(19) United States
(12) Patent Application Publication
(10) Pub. No.: US 2002/0099579 A1
(43) Pub. Date: Jul. 25, 2002

(54) Stateless, event-monitoring architecture for performance-based supply chain management system and method

(76) Inventors: David P. M. Stowell, Cupertino, CA (US); William A. Scelzo, Hayward, CA (US)

Correspondence Address: MINTZ LEVIN COHN FERRIS GLOVSKY AND POPEO PC, ONE FOUNTAIN SQUARE, 11911 FREEDOM DRIVE, SUITE 400, RESTON, VA, 20190, US

(21) Appl. No.: 09/765,345

(22) Filed: Jan. 22, 2001

(51) Int. Cl. G06F 17/60

(52) U.S. Cl. 705/7

(57) ABSTRACT

A stateless, event-monitoring server system for use in monitoring performance between buyers and suppliers participating in a performance-based, supply chain management system. A user interface web cluster comprises redundant web servers for bi-directional communications with users regarding events to be monitored between the buyers and suppliers. A data gateway web cluster comprises redundant web servers that provides a one-way data collection module for data related to products being supplied, buyers, and suppliers. A database cluster connects to the user interface web cluster and the data gateway cluster to access and store data to a database system. An application processing cluster connects to the database cluster to provide an application related to the events being monitored related to a buyer-supplier engagement.

RELATED APPLICATIONS

This application is related to the following commonly owned pending patent applications, all of which were filed on the same date as the present application: “Performance-Based Supply Chain Management System and Method,” Attorney Docket No. 58462.000003; “Performance-Based Supply Chain Management System and Method with Collaboration Environment for Dispute Resolution,” Attorney Docket No. 58462.000004; “Performance-Based Supply Chain Management System and Method with Automatic Shifting of Key Performance Indicators Based on Product Lifecycle Phase,” Attorney Docket No. 58462.000005; “Performance-Based Supply Chain Management System and Method for Monitoring Participant Performance Through Data Extractions from Exchanged Business Documents,” Attorney Docket No. 58462.000007; “Performance-Based Supply Chain Management System and Method with Metalerting and Hot Spot Identification,” Attorney Docket No. 58462.000008; and “Performance-Based Supply Chain Management System and Method with Automatic Alert Threshold Determination,” Attorney Docket No. 58462.000009.

FIELD OF THE INVENTION

The present invention relates to a stateless, event-monitoring server system with a set of user interface web clusters that have redundant web servers for bi-directional communications with users regarding events to be monitored between the buyers and suppliers and a set of data gateway web clusters that have redundant web servers that provides a one-way data collection module for data related to products being supplied, buyers, and suppliers. An application processing cluster connects to the database cluster to provide an application related to the events being monitored, such as a buyer-supplier engagement in a performance-based, supply chain management system.

### BACKGROUND OF THE INVENTION

Supply chain management is getting more complex and unpredictable (due to outsourcing, globalization, etc.). Pressure to do more with less compels suppliers, partners and customers to forge mission critical relationships. Forging these relationships into “trusted links” in trading networks is central to the issue of collaborative commerce. Existing decision support and supply chain management solutions are complex to implement within an enterprise and impossible to deploy across enterprises. While e-marketplaces have enabled dynamic connections between buyers and sellers, managing performance across networked supply chains requires significant resources and is difficult to do well. Managing partnerships is labor intensive and usually reactive. Establishing common performance objectives is typically overlooked. Existing technologies are fragmented, a burden to integrate, and not designed to adapt at Internet speed.

The trend towards outsourcing and partnering is increasing and complicated by emergence of trading hubs. The explosion of vertical and horizontal communities requires an ability to efficiently manage performance in networked supply chains.

Additionally, current supply chain management systems fail to enable buyers and suppliers to match up with each other in the most efficient manner and to enable them to monitor performance of one another in a meaningful way.

Indeed the supply chain process involves many aspects. No existing system provides a single solution to resolve all of those issues for buyers and suppliers in a single management system. Further, while many systems provide information to buyers and suppliers in a supply chain management process, the information provided is often difficult to interpret and meaningless when taken out of context and not delivered in time for action to be taken. Essentially, there is a massive amount of data being generated without the proper tools to help interpret that data for companies.

Additionally, networked supply chains have emerged without closed-loop performance management systems that work across companies, heterogeneous systems and processes. Management and operations often focus on fire fighting the same issues over and over again and therefore performance management is broad brush and anecdotal without provision for dynamic products/life cycle phase/region/partner context. Strategic innovation is driven more by off-line theoretical modeling or perceived competitive imperatives than by actual feedback from operational performance. Implementing supply chain improvement recommendations often proves impractical because embedding policy decisions in extended supply chain operations is too complex for most organizations to sustain.

These and other drawbacks exist with current systems

### SUMMARY OF THE INVENTION

It is an object of the present invention to overcome these and other drawbacks of existing systems.

An object of the present invention is to provide a context-specific, dynamically-created collaboration environment to resolve issues both synchronously and asynchronously.

Another object of the invention is to provide a system for monitoring business relationship health through monitoring standard business documents that are exchanged between partners and automatically extracting data that provides insight into that business relationship.

Another object of the invention is to quantify the health of business relationships by calculating key performance indicators (KPI's) from the data extracted from standard business documents. This process may provide “risk profiles” for individual links in trading partner networks. These risk profiles may help build confidence and trust in the links of trading partner networks. Through various embodiments of the present invention, “trusted links” in trading partner networks may be developed. In turn, then, that data may be provided as content into the partnership selection process to enable business partners to match up with other entities that share common business values.

Another object of the invention is to provide a system that provides a data extraction module that extracts meaningful data from business documents exchanged between supply chain partners.

Another object of the invention is to provide a system for connecting terms and conditions in business agreements with KPI's to monitor performance between business partners.

Another object of the invention is to provide a multi-nodal, distributed, stateless, event-monitoring engine/architecture that is robust and capable of implementation for many applications, including an application of the present invention for implementing supply chain performance management systems.

Another object of the invention is to provide a system that provides performance-based evaluation of partners that enables better selection of partners, better business relationships between partners and easier communication between partners.

According to these and other objects of the present invention, a system and method to provide end-to-end performance-based supply chain management. The system of the present invention provides modules and functionality to provide for set-up of a supply driven electronic commerce (e-commerce) system to allow buyers and suppliers to view others' capabilities, products and services. The system also provides assistance to buyers and suppliers to select partners that best meet their profile, based on past performance history. The system further provides functionality to allow potential partners to engage in negotiations to establish a business relationship through pre-defined templates for contracts, requests for proposals (RFP's), requests for quotes (RFQ's) and other terms and conditions. As discussed below, negotiations may be monitored to provide better context for decision making at operational levels.

The system then provides the ability for the participants to select pre-set business rules and customize business rules that are applicable to a particular arrangement between partners. The business rules features include a product lifecycle profiling component that incorporates the history of similar products (industry-benchmarked or client-specific). The system then monitors performance as it is occurring. Performance is preferably monitored automatically using pre-specified KPI'S, pre-set business rules and thresholds. In addition, partner performance is monitored through an automatic data extraction process enabled by providing a collaborative environment for conducting negotiations and resolving issues. This embodiment of the present invention provides resultant discussion logs and the ability to synthesize the content into searchable concept maps. Business users may be provided with historic resolutions and contract negotiations, sorted by relevancy using this content. If certain performance criteria are exceeded, notifications are issued to other partners to enable them to engage in issue resolution. For example, if one partner fails to deliver a shipment on time, the other partner is notified to allow for issue resolution by all involved in a supply chain.

When the system of the present invention identifies conditions that exceed user-defined thresholds for KPI'S, the system provides an on-line electronic room for issue resolution wherein the system monitors communications to derive performance criteria and thresholds. Prior issue resolutions are presented as options to enable partners to assist partners in determining an appropriate resolution. When resolved, a resolution is stored for future use in the system. Additionally, the system connects participants to transaction systems.

Then, the system provides for adaptation and learning based on the experiences of the partner relationship from negotiation, issue resolution and performance. The KPI's, business rules, thresholds and other metrics may be modified based on performance and fed back into the database to enable the system to use this information to provide better and more appropriate functionality to the partners. Data relating to performance and negotiation is then stored in association with a participant in a partner directory to be used in the future to select partners and resolve issues.

To enable data extraction, a common template-based communication protocol may be provided that enables a data extraction engine to more easily extract communication dialog between potential partners during negotiations as well as partners during the engagement of a contract. Through the present invention, programmatic ways of connecting contractual document commitments to the KPI's being monitored are provided, including loosely coupling contractual terms and conditions to KPI's. In this configuration, the system notifies relevant policy owners of KPI's when the governing contracts have changed. This notification initiates changes to the KPI's and thresholds based on contractual changes. This embodiment is particularly useful for linking contractual terms and conditions to KPI'S. KPI's, metrics and thresholds may be embedded as tags in the templates so the system can more readily extract the meaningful monitoring criteria. Additionally, special electronic “rooms” are provided for negotiation and issue resolution. In these rooms, participants are able to engage in a dialog in a format whereby the system is able to readily extract the key issues being raised by each party to better understand the KPI's and business rules that are important to that participant.

Therefore, KPI's, business rules and thresholds may be adapted on-the-fly by the server system to improve business relationships encountered by participants of the server system. Intelligent goal setting based on tradeoffs among KPI's, trends in KPI's, correlation among KPI trends, and product life cycle profiles are some of the important features of the present invention. These changes are presented to users as requests for decisions (decision requests). Users have the ability to accept, change, reject, or ignore decision requests. For example, the system of the present invention may provide an analysis engine that notices that 50 days of supply are being held in Singapore for a particular product when the threshold has been set to 10 days for that particular product. The system may send a decision request to the responsible party (or parties) asking whether the inventory level should be reduced. If approved, a workflow is triggered to request an operational user to execute the policy decision.

According to a specific embodiment of the present invention, A performance-based supply chain management system that provides a distributed, stateless, event-monitoring server system through which buyers and suppliers interact to be able to engage in contractual relationships for the supply of goods or services based at least in part on past performance with respect to key performance indicators identified by each party. The system monitors performance of contractual relationships between buyers and suppliers based on those key performance indicators, provides a collaboration module for either asynchronous or synchronous dispute resolution, and adapts and learns regarding data stored for buyers and suppliers for use in engagements and performance monitoring.

In this embodiment, buyers and suppliers use a terminal device to communicate to the server system over the internet or some other similar network. Communications between buyers and suppliers pass through the server system to enable the monitor module and collaboration modules to access communications between the buyer and supplier. Monitoring may be performed by extracting data from business documents passed between buyer and supplier communicated through the server system, such as through the use of a common mark-up language format (e.g., pXML) with tags to indicate important data, terms and conditions, key performance indicators and other information to be extracted. The system may extract terms and conditions from the buyer-supplier engagement, additional key performance indicators and other data and begin to monitor performance relative to the additional information.

Product lifecycles for products supplied through this system are derived and used to modify key performance indicators for which to monitor performance based on the phase of the product lifecycle. The system also provides alerts to buyers and suppliers regarding deviations from predetermined ranges for the key performance indicators for a contractual relationship. In one embodiment, the ranges are determined by the system based on historical ranges from performance of similar contracts by participants in the system.

In addition, when an issue with respect to the KPI is determined, a collaboration may be initiated with various participants being invited to an open, secure on-line environment where the issue may be resolved. Resolutions and collaboration data is collected and stored for use in evaluating participant performance and selection for other buyer-supplier engagements.

Alerts may be generated based on deviations, violations, changes or any parameters with respect to the key performance indicators. If a change does not occur by one participant, then the system may generate Metalerts relative to a monitored key performance indicator for a buyer-supplier engagement. Metalerts, or alerts about alerts, are transmitted upon the lack of a condition relative to a first alert sent regarding the performance of a buyer-supplier engagement. Escalating levels of personnel may be notified within an organization and eventually, the other contract member may be notified if a violation with respect to a key performance indicator occurs or is occurring. Through this functionality, the system is able to determine hot spots based on recurring alerts, alert severity, alert volume, pattern of alert responses or the breadth of alerts occurring within a particular engagement. This information may be stored for use in selection of buyers and suppliers by the system.

Alert thresholds may be automatically established by the system and altered based on historical data related to a key performance indicator to be monitored, including data related to products similar to the product being supplied in the buyer-supplier engagement, data related to the same product in the buyer-supplier engagement from other buyer-supplier engagements monitored by the system, data related to the same product in the buyer-supplier engagement from other buyer-supplier engagements supplied to the system, and data related to the same product from an earlier buyer-supplier engagement between the buyer and supplier.

To provide the server system described, a stateless, event-monitoring server system is provided that provides the hardware structure to enable monitoring of performance between buyers and suppliers participating in a performance-based, supply chain management system. A user interface web cluster comprises redundant web servers for bi-directional communications with users regarding events to be monitored between the buyers and suppliers. A data gateway web cluster comprises redundant web servers that provides a one-way data collection module for data related to products being supplied, buyers, and suppliers. A database cluster connects to the user interface web cluster and the data gateway cluster to access and store data to a database system. An application processing cluster connects to the database cluster to provide an application related to the events being monitored related to a buyer-supplier engagement.

Other objects and advantages of the present invention are apparent from reviewing the specification, claims and drawings provided herein.

### BRIEF DESCRIPTION OF THE DRAWINGS

The accompanying drawings, which are incorporated in and constitute a part of this specification, illustrate embodiments of the invention and, together with the description serve to explain the principles of the invention.

FIG. 1 depicts an overall system for supply chain performance management according to one embodiment of the present invention.

FIG. 2 depicts a network environment in which a supply chain performance management server system may operate according to one embodiment of the present invention.

FIG. 3 depicts a process of automatic data extraction by supply chain performance management system that intercepts messages between buyers and suppliers according to one embodiment of the present invention.

FIG. 4 depicts a supply chain management server system and database system according to one embodiment of the present invention.

FIG. 5 depicts a diagram illustrating results of use of the supply chain performance system according to an embodiment of the present invention.

FIG. 6 depicts a data flow diagram according to an embodiment of the present invention.

FIG. 7 depicts a process for enabling users to select preset business rules applicable to that particular user's enterprise according to an embodiment of the present invention.

FIG. 8 depicts a process to enable users to customize business rules applicable to their enterprise according to an embodiment of the present invention.

FIG. 9 depicts a flow for setting operational alert thresholds according to an embodiment of the present invention.

FIG. 10 depicts a process for setting management alert thresholds according to an embodiment of the present invention.

FIG. 11 depicts a process for multilevel alert notification according to an embodiment of the present invention.

FIG. 12 depicts an example product lifecycle chart for use in generating key performance indicators according to an embodiment of the present invention.

FIG. 13 depicts an example system utilization comparison showing benefits from using an embodiment according to the present invention.

FIGS. 14(a)-(c) depict an example set of messages to be generated, the analytics they provide and the key performance indicators used to evaluate these analytics to generate a particular message.

FIG. 15 depicts an example flow of data and materials to various participants of a system according to the present invention.

FIG. 16 depicts an example view of a partner rating system generated by an embodiment of the present invention.

FIG. 17 depicts an example view of management alerts that may be initiated based an operational conditions of participants in an embodiment of the present invention.

FIG. 18 depicts a chart showing responses to alerts derived from key performance indicators from a system according to the present invention.

FIGS. 19(a)-(b) depict data input systems according to embodiments of the present invention.

FIG. 20 depicts an embodiment of a server architecture for use in an embodiment of the present invention.

### DETAILED DESCRIPTION OF THE INVENTION

Reference will now be made in detail to the present preferred embodiments of the invention, examples of which are illustrated in the accompanying drawings in which like reference characters refer to corresponding elements.

An understanding of some terminology may assist in explanation of the invention. As used herein, the term “adapter” relates to software and associated hardware on which it is implemented that is designed to read from and/or write to and/or interface with participant systems. The term “agent” relates to software and associated hardware on which it is implemented that is designed to translate data between a native format and a selected common language such as pXML and transport the results between applications. The term “annual goods flow” relates to the value of goods physically transported between trading partners in a year (either calendar or fiscal).

The term “client application” relates to client-side software to be installed by a system participant, including adapters and agents. The term “trading partners” relates to the business entities with whom a system participant does business using the system of the present invention. The term “user” relates to an employee, independent contractor, consultant, or other agent of a system participant who is granted permission to access the system, such as through a user identification and password assigned to that user and/or system participant.

Further, through this specification, users of the system are described and shown as accessing various features through the use of a terminal device. It should be understood that the terminal devices through which a user accesses the system may be any type of terminal device available for data access over a network. In particular, it should be appreciated that the network depicted may comprise the Internet and any Internet-enabled device may be utilized. Other devices are also possible and other networks may also be used.

Some possible terminal devices include, but are not limited to, personal computers, laptop computers, personal digital assistants, pagers, mobile phones, email-specific devices (e.g., Blackberry), WAP device, telephone, and the like connected to a network via any number of methods, including DSL, cable, fiber optics, wireless, pager, and the like. According, by using the term terminal device throughout, it should be understood to indicate a device as described above.

The present invention is preferably embodied in a client-server arrangement wherein clients connect to a server using terminal devices. The server also connects to a number of third-party resources and systems to enable the functionality of the present invention. Communications between clients and third parties on the one hand and the server on the other may take many different formats. In a preferred embodiment, however, communications between clients facilitated by the server system occur using a standard server-specified format that enables data extraction, performance monitoring, and collaboration regardless of the terminal device used, network connection being made, or any other variable.

For purposes of the description provided herein, it should be understood that all descriptions herein related to collaboration or communication through the server system, a preferred method for all such communications/collaboration involves use of one or more standardized formats.

As part of this process, according to one embodiment of the present invention, a predetermined mark up language (e.g., pXML) may be specified to be used as the basis for all communications, agreements, collaborations and the like between clients (i.e., buyers, suppliers and third parties). This particular mark up language may then enable the embedding of metrics and thresholds in the document automatically as tagged information. Through the use of a mark-up language and tags, data extraction becomes easier and more efficient. If system-supplied templates are used, metrics and thresholds may be extracted by the system more readily because they are tagged with mark up language. Further, various other tags may be specified to indicate to the system what types of metrics and thresholds to monitor for a particular partner agreement. For example, if the contract changes between the parties, the change to the contract may be tagged separately so that decision requests to users with policy setting authority may be issued.

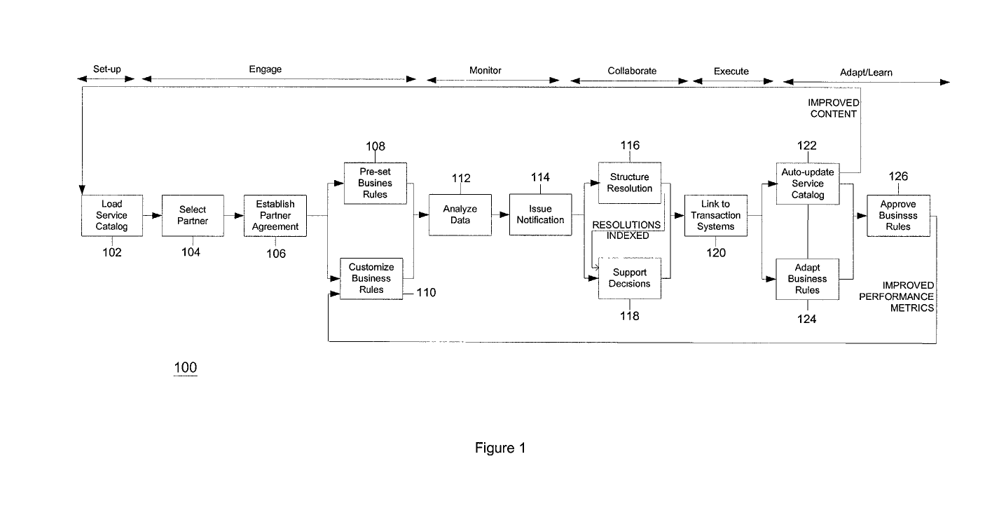

With that background in mind, FIG. 1 depicts an overall process 100 for supply chain performance management according to one embodiment of the present invention. As shown in FIG. 1, there are a number of aspects of supply chain management that are shown at the top of the diagram showing the flow of these aspects from one to the other. Specifically, there is a set up phase, an engagement phase, a monitoring phase, a collaboration phase, an execution phase, and an adaptation/learning phase.

While the invention is described in the context of an overall system, it should also be appreciated that many of the individual components may be separately used. The components shown may have independent novelty and usefulness apart from the overall system herein described.

In the setup phase, the step of loading a service catalog 102 may be performed. The setup phase and step 102 provide the basic information used for the overall supply chain management system 100 to operate. Partner information may be automatically loaded by the system based on content derived from e-commerce documents. This information includes partner profiles as detailed below. In particular, a partner directory may comprise a database that identifies the potential partners that are participating in the supply chain management system. The directory is the component in the architecture that underpins the entire partner location and selection process. Its responsibility is to collect, maintain and display data about potential partners.

For each potential partner, whether that entity is a buyer or supplier (or both), detailed information may be provided about that particular partner and the partner's preferences and richer performance attributes, extending well beyond those typically available today. The partner directory may include details regarding the products and services offered by the partner. That information may be automatically downloaded from commercial master registries. With links to those registries, this information may be periodically updated to ensure that the service catalog is up-to-date in terms of accuracy and timeliness. Specifically, an entity that participates may have different preferences as to the characteristics that are most important to that enterprise. For example, one enterprise may find that timely delivery is the most critical performance indicator whereas another entity may be most concerned with the percentages of defects received in the supply. All of this information may be detailed and provided in a database system that comprises the partner directory.

Message adapters may comprise the types of information that each of the partners are to send to and/or receive from the supply chain management system, the format that the message should take, the location and manner in which the message should be provided, and other information about the particular partner's messaging protocol and infrastructure.

Additionally, content is extracted from the supply chain management system. Many different types of content may be extracted. In particular, the content used to perform the tasks described in more detail below for the other functions of the supply chain management system may be extracted. Content may be provided to users based on their subscription level and authorization. Detailed content on private trading networks may be limited to authorized members of the network, while aggregated, anonymous content may be provided to an entity operating the overall system so that the overall system entity may be able to generate and provide industry and cross-industry benchmarking services. Content is developed as a natural consequence of using embodiments of the present invention. In various embodiments, several content categories may be made available to users of the system, including partner performance ratings by KPI over time, issue resolution dialogs, contract negotiation and change logs, product lifecycle profile types grouped by commodity types, agreement templates with standard terms and conditions.

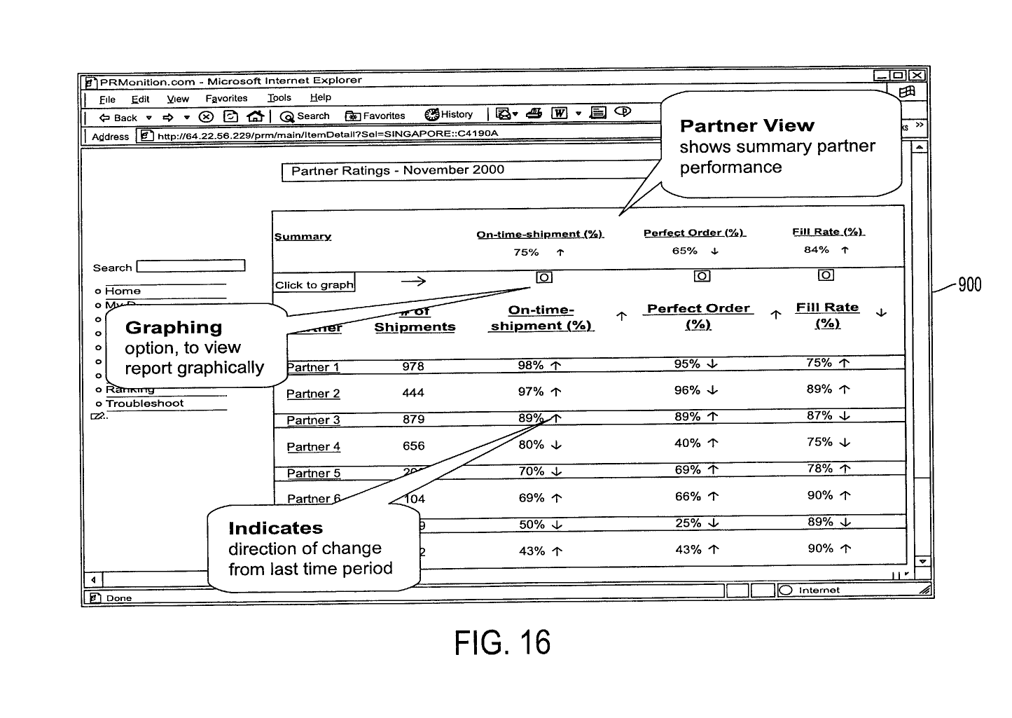

FIGS. 16-18 provide examples of views that may be presented by a system according to the present invention to provide content to users of the system. For example, FIG. 16 depicts an embodiment of a view for a user to see partner ratings with files to display each partner's number of shipments, the percentage of on-time shipments, the percentage of perfect orders, and the fill rate. Further, this view may present an icon to view a particular column graphically. Also, arrows may be provided next to a value to show a trend from the previous evaluation period (i.e., whether the partner's performance is getting better or worse).

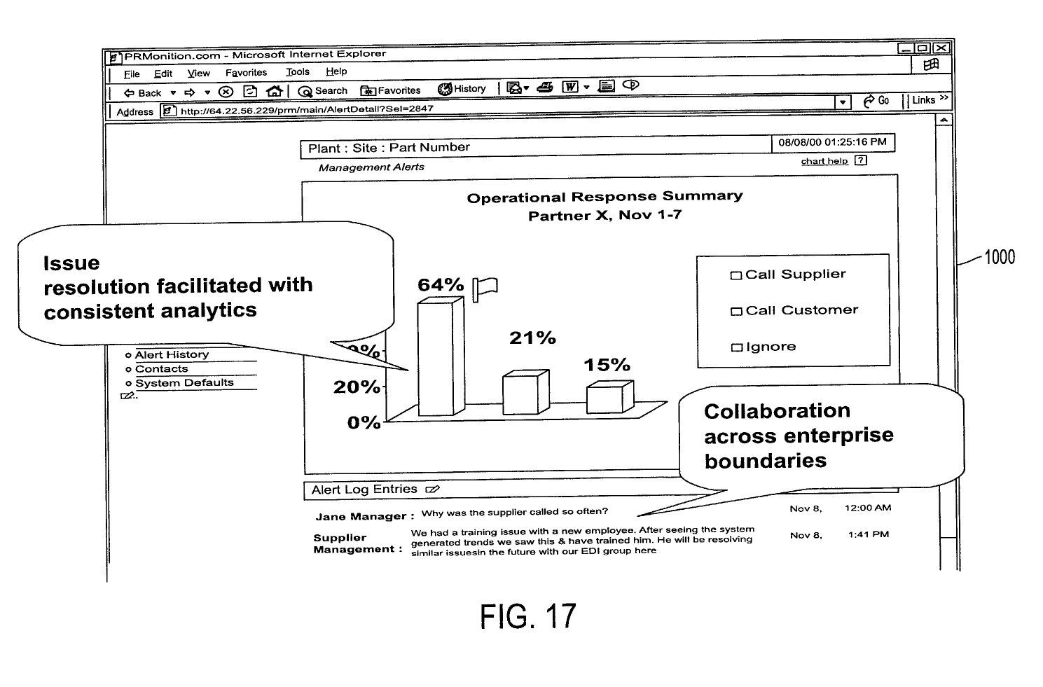

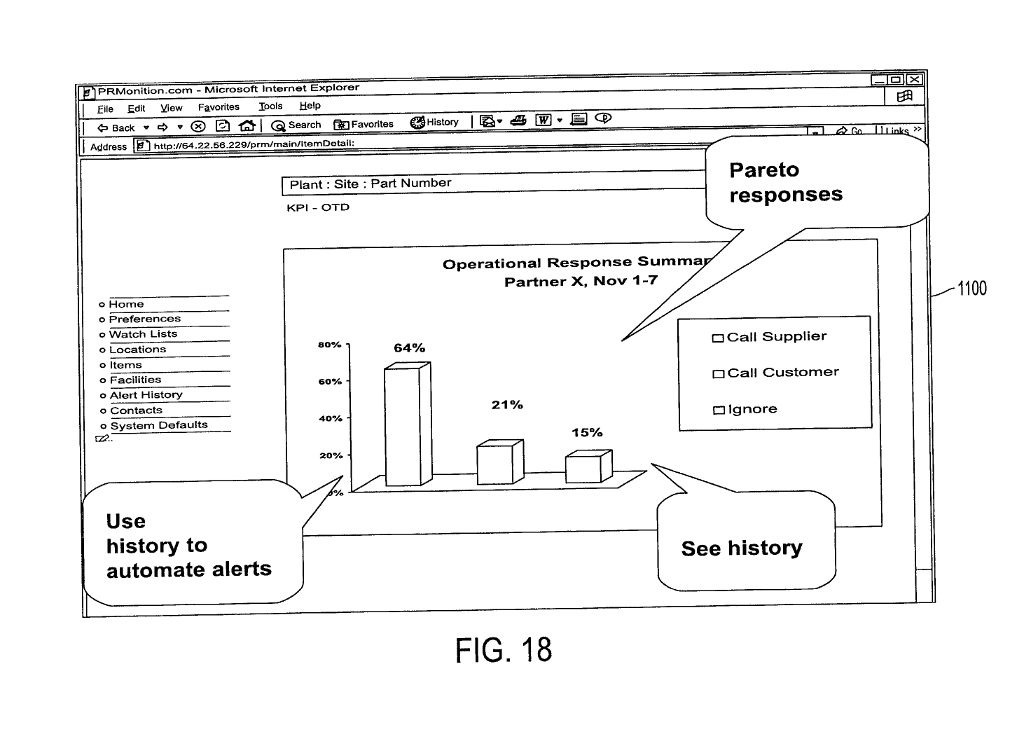

FIG. 17 depicts an online view of a Metalert issue collaboration. The Metalert has fired based on the operational response summary that has been generated based on response to alerts and a dialog of statements between partners logged to resolve the alert condition. Here, it appears that the supplier of a particular part had to be alerted a number of times and more than 64% of the time, the buyer contacted the supplier. This pattern triggered the Metalert threshold, causing Jane Manager to receive a Metalert. In response, the supplier provides a response to explain the situation. This information is then stored for later use in partner matching and the like. FIG. 18 depicts operational response summary characteristics and the response thereto, similar to FIG. 17.

Additionally, a community aspect may be provided in the service catalog, which provides for communication between partners sharing of ideas, location of resources and other community based information that is helpful to an enterprise participating in supply chain management systems.

After the system has been set up, the engagement phase may be undertaken by the supply chain management system. As a first step in the engagement phase, a step 104 of selecting a partner may be provided. In particular, in step 104, the system attempts to match up buyers and suppliers based on preferences provided by each of these enterprises. The preferences may also be extracted by the system as users transact normal business with existing partners. Once the user has selected one or more partners, the system provides a mechanism where the user can generate an RFQ (using pre-defined or user-defined templates) and have the request delivered to the partners in a secure fashion. As part of the process the user can specify whether the bidding is public or private. The system organizes the bids, attaches any available partner profile content and allows the user to select the winning bid.

As part of this partner selection process, one phase is to identify the KPI's for each of the potential partners. For example, if a buyer is requesting a supplier for a particular type of good, a listing of all suppliers of that good are extracted from the database first. Then, the performance indicators important to the buyer are identified based on that buyer's preferences and other input received from the buyer. Additionally, various performance expectations may be set by the buyer and/or supplier for the particular contract to be undertaken. For example, the expectations may include the amount of time, the quantity required, or other indicators important to the contract. That information is useful to help identify the best match for a partner. For example, if a buyer requires that it wants to buy a million ball bearings over the course of a year, it is important for the supplier chosen to have the capacity to be able to fill those orders. Other expectations may include: ability to have the demand fulfilled in spikes; suppliers with production flexibility to accommodate short-notice changes in total demand and/or product mix; geographically dispersed production and/or distribution centers to guard against disruptions stemming from natural disasters, etc.

Additionally, the buyer and/or seller may be asked to select one of the predetermined RFP's or RFQ's that have already been stored in the database system during the setup process. For example, for particular types of goods, pre-designed RFP's may be already stored in the system. By selecting a predetermined form, the buyer spends less time worrying about putting together an RFP and more time focusing on the KPI's that are important to that buyer. Additionally, it should be appreciated that buyers and suppliers may create or modify existing RFP's and save those for future use. As part of this process, the RFP may be added to the directory so that others may use the same RFP in the future. Additionally, whenever a buyer or supplier creates or modify a new component, the preferences are then updated for that particular partner so that the system stores knowledge that the particular RFP is to be used as the default for that particular partner.

Next, as part of the partner selection step 104, the system evaluates the fit for the buyer and other potential suppliers. The fit evaluation process may entail comparing KPI's that have been selected and identified by the particular buyer, expectation specified, and RFP's/RFQ's provided. Those RFP's/RFQ's may be sent out to potential suppliers to see if they are interested, or may automatically be matched up to particular suppliers as well. As described in more detail below, the evaluation of a fit may also be based on past performance between the two potential partners. For example, if a buyer and supplier have transacted business in the past, their past performance history together may be used to determine whether or not to fit them together again. For instance, if the two partners had an issue, that factor may be used to determine whether or not to fit those two partners together again.

The next step in the engagement phase is to establish a partner agreement in step 106. Once a bid has been accepted, the partners negotiate terms and conditions for the engagement. The system provides standardized templates and also allows the user to supply their own.

As part of this step, the supply chain management system provides predefined templates of agreements for use by the various partners in forming an agreement. These templates may be very specific to a particular type of good being supplied, to a geographic region, to state, or any other level of detail desired. For example, when dealing with suppliers from different countries, a particular template may need to be specified so that customs duties and other international contract issues are specified in the agreement. The system may also provide example templates and act as a repository of partner-specific agreements to be used as a starting point for negotiations. In one embodiment, the provider of the templates does so without certification as to their legality. Additionally, as with the RFP's as described above, buyers and suppliers may specify their own templates to be associated with that buyer or supplier to be used for that specific buyer or supplier. For example, a particular buyer may have a particular template that it prefers to use and may have that template stored in the system associated with that buyer so that when contract negotiations begin, that template is automatically selected by the system as an initial contract proposal. The requirements of such a template may simply be that the relevant metrics used to calculate KPI's are specified.

Next, as part of the partnership agreement step 106, the system may track negotiations between the two potential partners. The system may also provide the ability to track changes and provide change logs on agreement documents. Additionally, these changes may be linked to KPI's and therefore act as a basis for decision requests around KPI thresholds and tests when governing agreements change. In some cases, users may replace or augment their own agreement templates for those made available by the system as default templates. The system's pre-defined templates, tags and conventions within the template make it possible to gain more specific details on particular clauses and passages that pertain to terms and conditions. In particular, as described in more detail below, communications between two potential partners may all pass through a common server system and be monitored by the supply chain management process. As such, as part of the tracking process, data may be extracted relating to the terms and conditions and metrics that are discussed between the two potential partners. This information may then be subsequently stored in the database associated with those partners for future reference. For example, if a particular buyer requires in the agreement to have a per day penalty if the supplier fails to supply desired goods on a particular time, then that requirement is then extracted based on the negotiations between the parties and stored in association with that particular buyer. In the future, when trying to match that buyer up with other potential suppliers, that factor may be taken into consideration to determine whether or not a potential supplier can satisfy or will be agreeable to that provision.

Once an agreement has been reached between the two partners, then in step 108, business rules for these particular partners are created based on a combination of automatic and manual input. These details about historic performance are used to help business policy makers (e.g., KPI threshold setting assistants) set alerts, notifications and expected responses. The monitoring phase uses these configuration details. Additionally, in step 110, customized business rules may also be created.

In step 108, the preset business rules may be based on one or more of the following: forecast history, user role/responsibility profile, inventory history, order history, past partner performance, and commodity lifecycle profiles. Specifically, forecast history may provide data relating to the ability of buyers and suppliers to forecast the amount of product and the timing when that amount is requested.

This kind of information is helpful in developing “confidence factors” to help users interpret future plans and commitments based on past performance. For example, if a partner's planning process has resulted in high error, the confidence factor around interpreting new plans from that partner may be low. By differentiating high confidence from low confidence plans and commitments in an e-commerce context, business users can focus attention on low confidence (high-risk) transmissions and allow high confidence (low risk) transmissions to flow more automatically to their execution systems. This ability to focus attention and resources on high-risk areas is an advantage of the various embodiments of the present invention. Product lifecycle predictions may be derived from patterns in similar commodities over time. Specifically, the predictive analytics pack recommends smart goals and the right KPI's on which to focus by similar products. The system may use past history (from the system's base module or a direct feed of historical data from ERP systems) and develops lifecycle profiles for similar products. These profiles are then used to recommend the appropriate KPI's to focus on. An entity affiliated with the host system may also recommend the optimal goals, by KPI, that maximize margins. These goals are calculated based on the lifecycle profiles, past performance and trade-off analysis among various KPI's.

As an example, business rules may be set to optimize KPI's by tracking various inputs, providing various features/functions, and from those features/functions, generating outputs. Inputs may comprise the following: history of sales by products, introduction and obsolescence dates by product from an ERP system and cost data by product. History of sales by products may be derived from various options, including a module in this system that tracks sales by product based on data collected by base package installation or from a direct dump of history from an ERP system. Cost data may be extracted from various sources, including a module in the system that monitors business-to-business message flows and a direct feed from an ERP system.

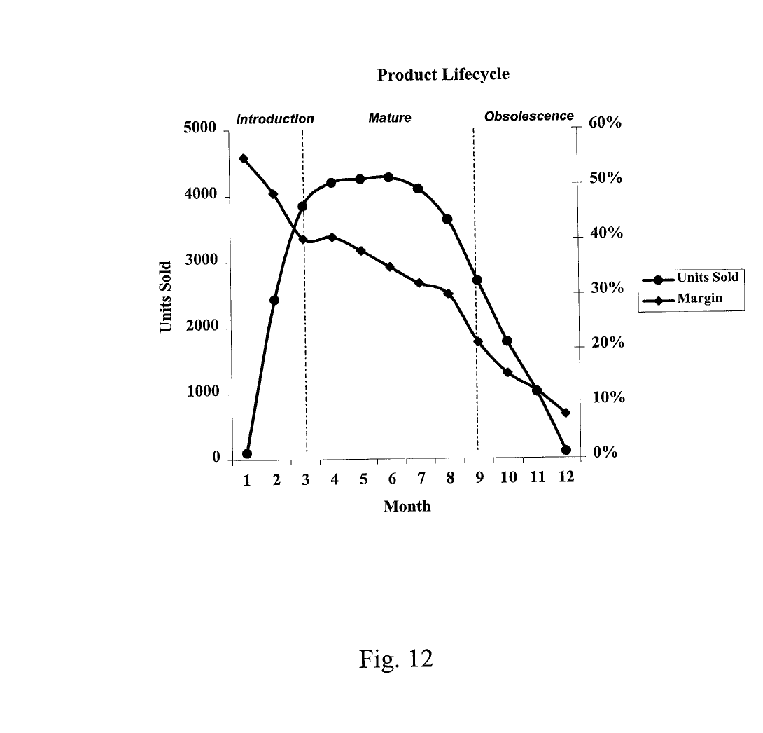

From this information, product lifecycle profiles may be generated. An example of a product lifecycle profile is depicted in FIG. 12. As shown, the product lifecycle may be segmented into three (or more) phases—introduction phase, mature phase and obsolescence phase are depicted in FIG. 12. This profile may be generated from the inputs and/or derived from history built from data collected by the system over time for comparable products. Such databases may be enhanced through data records regarding comparable products as well as standard products such as (i.e., Laptops, Desktops, etc) from market resources (e.g., Hoovers, D&B) to build typical product profiles.

The derived product lifecycle generated may then be stored and grouped with products with similar lifecycle profiles. Then, based on historical data for similar lifecycle profiles, the system may then recommend KPI's that are most relevant by lifecycle phase above, in order of importance (e.g., service Level being most important for Introduction phase with Days of Supply being least important, and vice-versa for Obsolescence phase). These recommendations are accompanied by a graphical view of where the product is in the lifecycle phase, and users can accept recommendations or change the lifecycle transition points in a graphical manner.

In addition, the system may provide a module for recommending optimal goal levels for each KPI that leads to most effective asset utilization at each lifecycle phase. This may be done via algorithms that calculate the tradeoff costs between different KPI's (i.e., Service Level vs. Days of Supply, vs. Cycle Time etc.). Again users may then be shown goals and an indication where a product is in the lifecycle phase in a graphical fashion, and may be allowed to accept the recommendation, or change the goals and or the lifecycle transition points.

Additionally, the system enables users to track KPI performance by product lifecycle phase and build history. This history is then used to suggest confidence levels around different KPI's. So if forecast error is particularly high in the Introduction and Obsolescence phases for a particular product type, then this is factored into the equation when suggesting goals and recommendations by the system.

The system uses this data to further alert users about looming lifecycle transition points, recommend the new KPI's with new goals for the next phase, and let users agree to the recommendations or graphically change the transition points and or the goals.

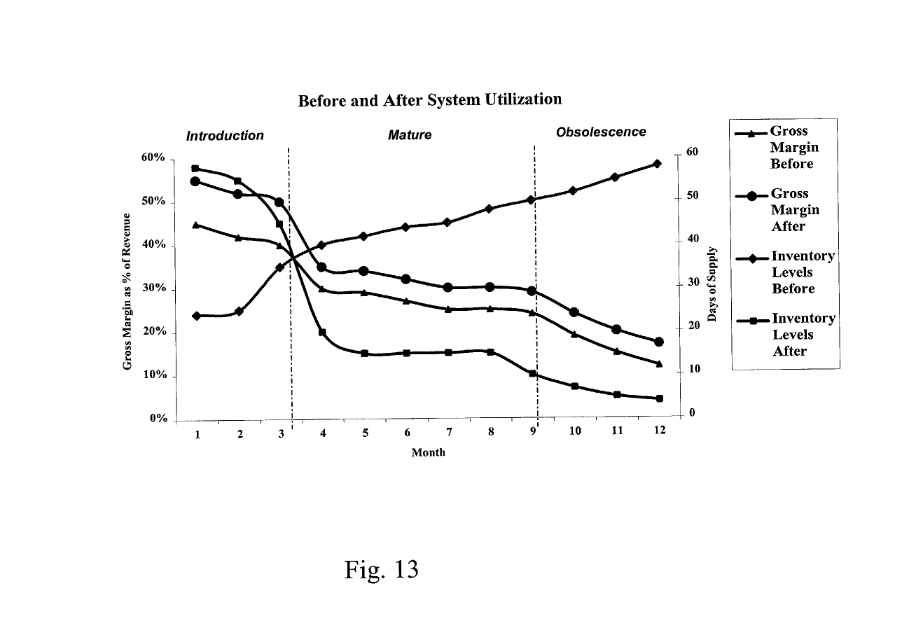

The benefit of this business rule process of step 108 is shown in FIG. 13 below. As FIG. 13 illustrates, using predictive analytics as provided in the present invention around product lifecycles leads to consistently higher margins throughout the lifecycle, with inventory levels appropriate for the lifecycle phase

Additionally, user profile information may comprise the company information about that particular buyer and supplier. Inventory history may comprise information about the amount of inventory for the buyer as typically maintained and that the supplier typically had available for shipment. Next, the order history of the buyer and supplier is input and the performance criteria of those are also input.

In a preferred embodiment, the preset business rules apply to all users that focus on a particular item. These business rules set a likely definition of what critical and warning levels should be. If users are allowed to adjust (personalize) thresholds, then alerts are personal and it is possible that there may be many simultaneous resolution sessions for the same item. In an embodiment, an alert is generated and the alert owner is responsible for resolution. The alert owner is capable of assigning alert resolution responsibility to other authorized users of the system. Any other user can view the alert and also collaborate on the resolution if they have access to the alert.

In addition, it may be desirable to allow for users to customize (or personalize) the threshold limits. If this is the case, the user overrides the default setting for the item. The server, when processing the data, first checks to see if anyone has overridden the default values. If users have, it then executes each override in turn and generates the notification (if applicable). This may be achieved in a customized business rule step 110.

In the customized business rule step 110, the buyer and supplier input changes to groups, thresholds, and alerts. Specifically, the buyer may select to be alerted based on inventory shortages, over-stocking and the like. Next, in the monitoring phase, the first step, which may be an iterative process, involves analyzing data in step 112 and then issuing notification in step 114, if necessary. The system not only provides for the setting of thresholds on discrete events (e.g., a stock outs should be limited to 2%), but on the acceptable number of alerts over specific time periods, average time to close alerts, and the operational response profile to operational alerts. These alerts about alerts are termed “Metalerts” in the system. Metalerts are geared toward management teams who are interested in identifying performance trends that represent risk to their trading networks.

In step 112, the data that has been input from the pre-set business rules and the customized business rules are monitored closely based on performance by the appropriate trading partner(s). In order to monitor the day-to-day performance of the relationship, the system monitors the KPI's of the relationship.

To do so, the relevant pieces of data between buyer and supplier are extracted from commitments in the normal flow of e-commerce messages and pass through the common server system. The server system can determine whether or not violations of business rules are occurring. The data analysis process involves determining whether violations occur, establishing trends between these two partners, and identifying the severity of a violation as well. For example, if a particular supplier had required that the buyer order a certain number of units within the first month, and communications between the buyer and the supplier indicate that that order was never received, a violation may be determined in step 112 based on communication between the buyer and supplier. Similarly, ordering patterns and so forth may be extracted as trends in the data analysis portion 112. As new data is received from the agents, the server analyzes the information and calculates the moving averages for the KPI's.

In the collaboration phase, one or more steps may be undertaken based on the result of a violation. In step 116, the system may help structure a resolution. IN particular, a collaboration environment, such as a room provided by eRoom, may be initiated with participants to resolve the dispute (e.g., the buyer and supplier of an engagement for which a violation has been detected). This dispute resolution may be synchronous or asynchronous, thus enabling greater flexibility based on each participants' availability. Standardized formats may be employed to enable data and information extraction from dialogs between collaboration participants.

The resolutions may then be indexed and provided to step 118 where the system supports decisions. Specifically, prior solutions may be archived with information regarding how the resolution transpired. Tradeoff analysis and violation details may also be stored and associated with the partners affiliated with the violation. This collaboration allows the system to provide meaningful performance criteria evaluation for use in the future in analyzing whether or not particular partners are suitable for other partners. When an issue is resolved, the issue text and any associated discussion is archived into a resolution database.

In step 120 in the execution phase, a link to transactions systems may be provided to enable the partners to engage in certain transactions. For example, single click access to trading exchanges, vertical hubs, and ERP/APS systems may be provided in the execution phase.

In the adaptation/learning phase, various steps may be undertaken as described above to enable the system to provide better input as to selection and monitoring of performance amongst partners in the supply chain.

First, in step 122, the service catalog is automatically updated with the content collected to the various phases. This information includes the selection of a partner, the terms selected during negotiation, the KPI's to be evaluated, actual performance statistics, trend analysis and other details that may then be fed back into the service catalog in future processes. While monitoring the day-to-day metrics of the partners, the system has the ability to update the partner directory with up-to-date information about how the partner is doing compared to their peers. Additionally, in step 124, the business rules that are used to monitor performance may be altered to take into consideration the analysis derived. Various artificial intelligence engines may be implemented to achieve this result. Several include the following:

Problem Prediction—by looking at historical data, the system can predict problems before they occur. One example is the prediction of stock-outs. By taking the past consumption, past receipts (frequency and amount) and then looking at the current inventory the system can do some basic extrapolation.

Opportunity Identification—by using the above techniques, the system can suggest when inventory stocks may be too large given historical data. The dataset that this subsystem uses is held within the repository and does not need to be processed in line as new data is received. The processing can be scheduled for low activity hours.

Neural network, genetic algorithms and other non-linear approaches that focus on interaction between systems in complex, adaptive systems may be applied to this process step. The most important outcomes are: to identify causality among metrics and to deliver consistently plausible recommendations.

Once new business rules are determined, the business rules may then be submitted for approval in step 126 and then fed back through the process to the customized business rule step 110 for use in future processes. Once the system has determined that some action needs to occur, it invites the user to either ignore the recommendation (supplying a reason) or make adjustments to the baseline. This adjustment is applicable to “standardized” metrics level and not the user-defined adjustments. As part of the adaptation of the business rules, emerging causality, intelligent goal setting and performance improvement timelines may be provided. These three components may be used individually or in combination to help business users tune KPI thresholds over time. All of these steps may then provide an overview of the performance or supply chain performance management system of the present invention.

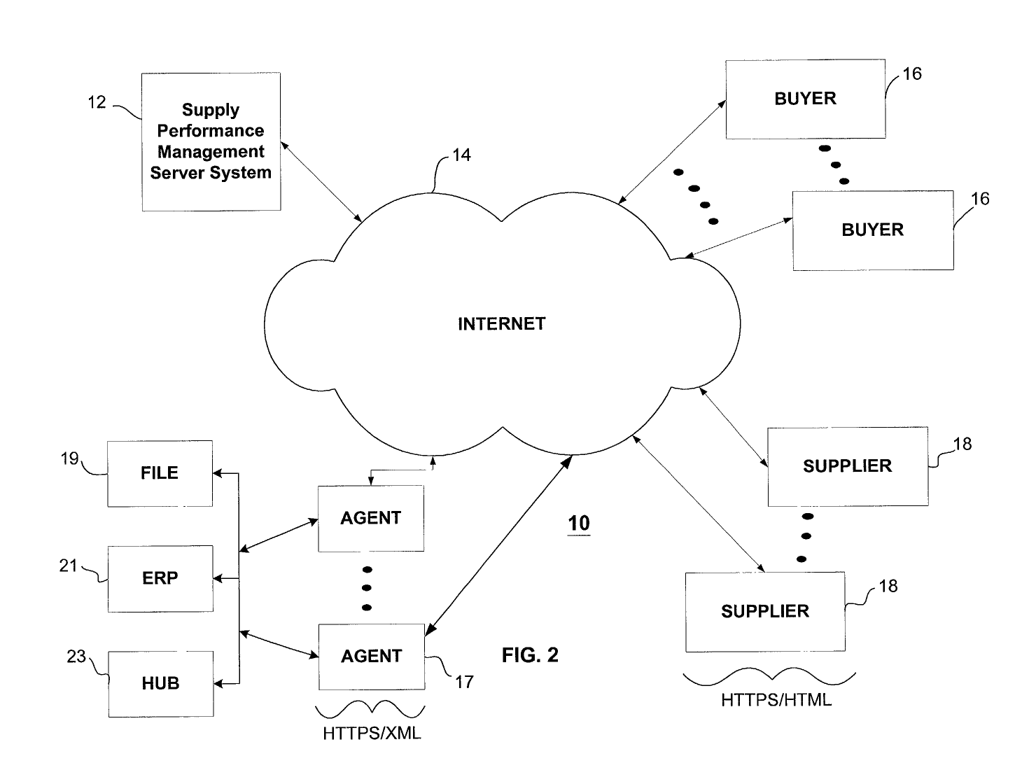

According to one embodiment of the present invention, the supply chain performance management system may be provided as an internet-based system to enable buyers and suppliers disbursed throughout the world to connect to one another and engage and participate in the system. One embodiment of such a system is depicted in FIG. 2 wherein the system 10 comprises one or more supplied performance management server systems 12 that are connected to the internet to a plurality of buyers 16 and suppliers 18 to communicate using current and future enhancement to internet protocol communications.

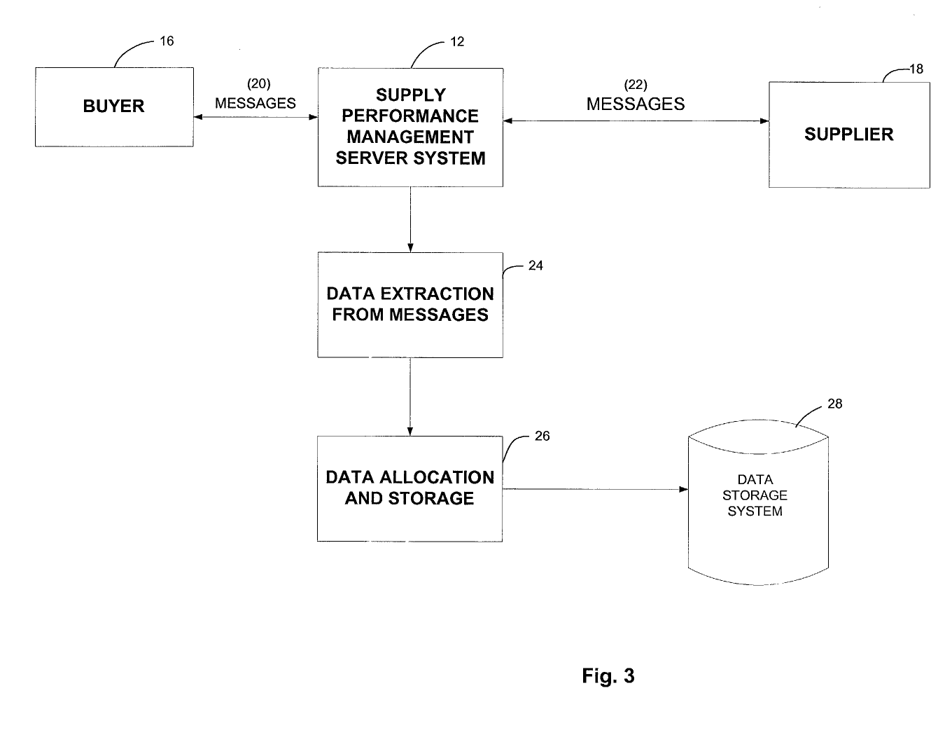

According to one embodiment of the present invention, it is important for the supply chain management system 10 to know and be a part of selected communications between buyers and sellers from the initial match-up all the way through the performance between the two partners. Accordingly, FIG. 3 depicts an embodiment of the flow of communications between buyers and suppliers. Specifically, a buyer 16 may communicate with supplier 18 through messages that are passed through supply performance management server system 12. For example, the messages 20 passed from buyer may then be transmitted through to supplier 18 who may create messages 22 to pass back through supply performance management system 12 to buyer 16. The message may take the form of structured (EDI/XML) and semi-structured (spreadsheets) electronic communications that are copied to supplier performance management server system 12. Notification communications may be electronic, voice or telephonic, such as electronic mail, instant messaging, facsimile or other forms of electronic communication that may occur over the internet or any other communication media. When messages pass through supply chain performance management server system 12, those messages may be loaded into the repository where tests are run to determine whether KPI thresholds have been violated. These data are allocated and stored in step 26 into a data storage system 28 for use in evaluating performance of these particular partners and for using that information in matching up partners in the future.

To provide the functionality described herein, supply performance management server system 12 may comprise a plurality of components that perform specific tasks within the system. It should be appreciated that the server system 12 may comprises a plurality of actual server systems operating in parallel in order to handle the traffic load of a number of partners that are participating in the system. Each of these server systems may have each of the components described below or may have only certain components to help operate in parallel.

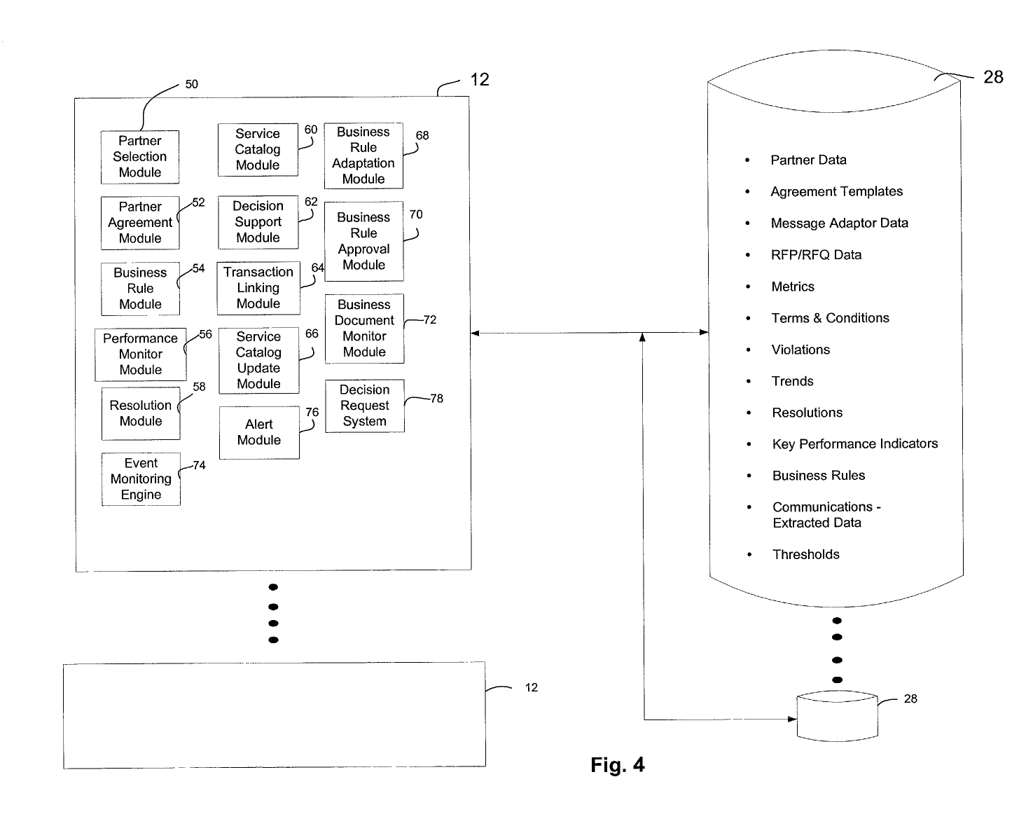

FIG. 4 depicts an embodiment of the supply chain performance management server system 12 and database storage system 28 according to one embodiment of the present invention. The server system may comprise a foundation that contains a database connection pooling mechanism, thread pooling mechanisms as well as a mechanism to perform operations in an asynchronous/distributed manner.

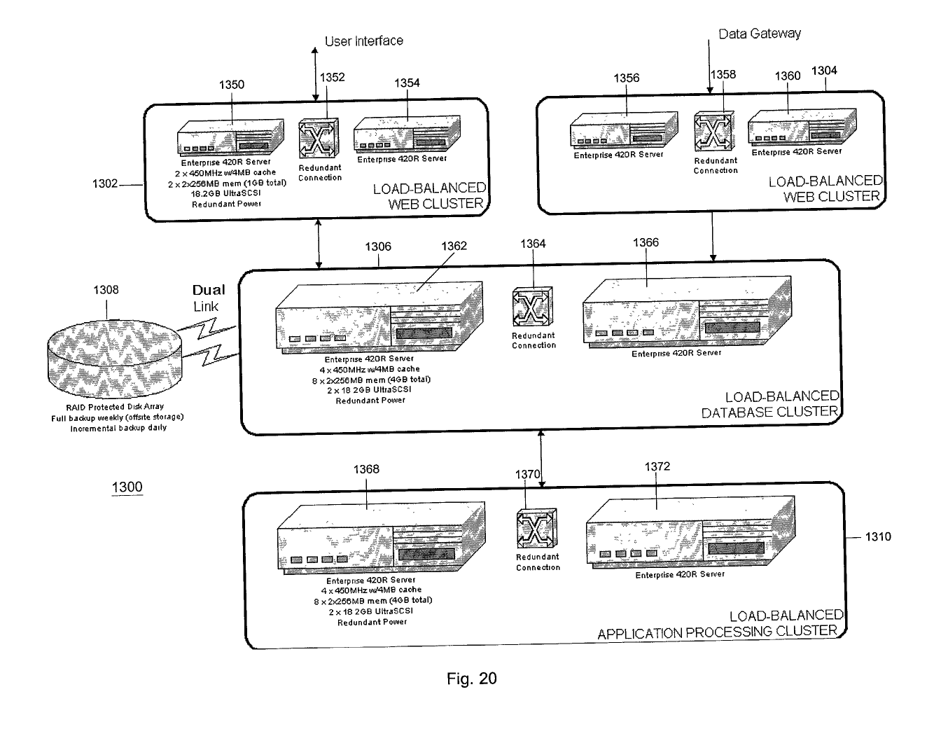

As discussed above, the preferred embodiment for at least a portion of supply chain performance management server system 12 is a multi-nodal, distributed, stateless, event-monitoring engine/architecture. A specific example of such an architecture is depicted in FIG. 20. In this system, server system 12 may comprise a multi-nodal, distributed, stateless architecture 1300. This system 1300 provides a user interface and a data gateway for collection of data from exterior sources for use in providing resources for the performance based supply chain management system. The user interface connects into a load-balanced web cluster 1302 that comprises a plurality of server systems such as servers 1350 and 1354, connected using a redundant connection 1352. In one embodiment the servers may comprise an Enterprise 420R server with 2×400 MHz with 4 MB cache, 2×2×256 MB memory, 16.2 GB UltraSCSI and Redundant Power offered for sale by Sun Microsystems.

The data gateway may connect into a load-balanced web cluster 1304 that comprises a plurality of servers 1356, 1360 connected through a redundant connection 1358. These clusters may be connected to a load-balanced database cluster 1306 and a load balanced application processing cluster 1310 providing servers 1362, 1366, 1368, and 1372 with redundant connections 1364 and 1370. The load-balanced application processing cluster 1310 may be the location where a plurality of the modules (e.g., see FIG. 4) described herein may reside.

Also, through a dual link, the database cluster 1306 may be connected to a disk array database system 1308. The disk array may comprise a RAID Protected Disk Array that may be incrementally backed up daily and fully backed up on a periodic basis (e.g., weekly) and maintained in a safe location.

A number of the component areas utilize the ability to reliably process information. During this process, the system does not want to block the client (be it a user or agent). The foundation provides a reliable callback mechanism so that the component may release the user/agent, but still be guaranteed an opportunity to process the request.

The system contains a number of components that provide different services to the client, such as partner location and metrics monitoring. The foundation is responsible for tying these components together into a single logical unit. In one embodiment, there are many different functions happening simultaneously within the server. A number of these functions access the repository for either storing or retrieving information. A database connection is an expensive thing (in terms of memory and set up time). The database connection pool allows the system to pre-allocate a number of these connections and also share the connections when possible. The database pool attempts to maintain a number of connections to the database. It creates new connections as needed, but then closes them if it exceeds the pool size, thus bringing the connection pool back under control.

When the server is processing work, it uses threads to allow the operations to be performed in parallel. On some occasions a large amount of work needs to be processed and if a thread pool was not employed, the server could spawn thousands of threads in an attempt to get through the operations. The pool allows a finite number of threads to be made available and then manages the threads over time. If someone requests a thread and all the threads in the pool are currently in use, the client is (optionally) blocked and then released when a thread is available.

A number of the components perform operations in an asynchronous manner. If the component is not going to execute the operation in line it is important that it does get executed eventually. The callback service is responsible for reminding the component that it still needs to perform the operation. In order to make the callback mechanism reliable, the database is used as a reliable queue. The use of the database as a central queue also brings other benefits. The server (being stateless) can be replicated across a number of machines and then allow for huge scalability opportunities.

To allow this functionality, supply chain performance management server system 12 may comprise one or more of the following modules: partners selection module 50, partner agreement module 52, business rule module 54, performance monitor module 56, collaboration/resolution module 58, service catalog module 60, decision support module 62, transaction linking module 64, service catalog update module 66, business rule adaptation module 68, business rule approval module 70, business document monitor module 72, event monitoring engine 74, alert module 76, and decision request system module 78. These modules may perform the functionality described above with respect to FIG. 1 to which they correspond.

Specifically, partner selection module 50 may be responsible for performing the functionality to enable partners to be selected.

According to a preferred embodiment, the system supports “simple” purchases as well as more complex “strategic” and demanding relationships. The buyer selects partners using two main methods. When buying commodity goods, the identity of the supplier is generally deemed to be unimportant (within reason). If they are reputable and have the items needed, cost is generally the main factor.

When performing other buying operations, there is a “relationship” that is either in place or needs to be created. The selection criterion tends to be more complex and the selection process taken more time.

This module is responsible for identifying potential partners and determining if they can provide the service/items desired by the other potential party. It takes as input the partner directory and generates a selected partner that is then processed by the partner agreement system. Partner selection consists of first locating the partner and then determining if they are acceptable.

Acceptable may mean that the potential partner has demonstrated performance attributes consistent with the requirements of the buyer. The location process works in two modes. The first allows the user to find a partner based on attributes such as name, location, SIC code, etc. The second allows the user to find a partner based on KPI performance indicators. For example, find all partners with forecast error performance ratings of less than 40%.

The system allows the user to query the directory using any of the attributes associated with a partner. In one embodiment, the user may be presented with an HTML form containing fields that represent the attributes of a partner such as name, location, SIC code, etc. When the form is submitted, a query is performed on the partner directory and the resultant partner entries are returned. The user is presented with a list of partners that they can then short-list. This short-listing process involves the user marking the entries that they wish to pursue.

The system also allows the user to enter part numbers or descriptions and query the inventory of relevant partners. The user provides the industry within which to search for the items. This may be enabled via a dropdown list of the SIC industries. Once the user has selected the industry and provided partial or full part number or description, the system obtains all the inventory URL references for that industry and initiate a query against all the partners.

Once the user has located a short-list of potential partners, they may need to go through a RFP/RFQ process. The system allows the user to create an RFP/RFQ and communicates this request to the short-list partners.

When the user enters this stage, the system guides the user through the RFP/RFQ process. The system provides default RFP/RFQ templates and also allows the user to upload its own documents.

Once the user has created an RFP/RFQ, that user submits the request. The request can have various options, including published buyer (e.g., the name of the buyer is made know to the potential partners), anonymous buyer (e.g., the name of the buyer is withheld from the potential partners), public request (e.g., the request is published on the server system and is open to anyone), private request (e.g., the request is only published to the selected partners), public bids (e.g., the responses from the potential partners are visible to the other participates), and private bids (the responses are “sealed” and only visible to the requestor).

The request is held on the system site and the partners are notified via e-mail that the request exists. The system allows the partner to respond using the standard template or user-defined template. The partner can change the response at anytime up until the request closes. The user is notified each time a response is received. The responses are consolidated within a folder so that the user can easily review them. Once the user has found an acceptable partner, the response is accepted and the partners are notified.

Partner agreement module 52 may provide the functionality to enable partners to reach an agreement, such as providing templates, monitoring negotiations, and enabling the agreement to be executed. The agreements are held in a secure environment under change control. This allows for both parties to view the single definitive version of the agreement. Each engagement with a partner is housed within its own environment allow easy management of multiple ongoing relationships.

Once a bid has been accepted, a “room” may be created for both partners to negotiate the terms and conditions for the engagement. The system provides default contracts, but also allows the users to upload their own documents. The room is a secure environment allowing access by the user and the partner. In a preferred embodiment, no other user may view or modify the documents.

The documents are held within a change control system and all changes are logged. Both parties are notified whenever the documents change. These change notifications may include a list of KPI's, alerts and thresholds currently associated with the agreement. Appropriate users may be asked to review these details to determine if the business agreement change has impacted lower level control parameters. If so, appropriate users may be provided with tools and content to help adjust control parameters per the new business arrangement. For example, if a buyer decides to “pay on ship” rather than “pay on receipt,” on time delivery KPI thresholds may no longer be necessary and a new on time ship KPI may be appropriate. By presenting these kinds of logical connections in a change management context, the system helps business users embed the intent of their strategic agreements in operational policy. In this way strategic changes are quickly and consistently translated into day-to-day behaviors and the overall performance management system continually adapts to evolving business practices. This provides another significant advantage of the present invention.

When the bid is accepted and the room created, both partners are notified that the negotiation space is available. The functionality for this system may be provided by third party vendor, such as a company called eRoom. The information exchange/process may be unstructured at this point.

The system offered by eRoom provides a notification mechanism that detects when an agreement is finalized. When this occurs, the system extracts which KPI's the partnership cares about and what the critical thresholds are for the metrics. In all cases, the system allows users to create loose connections between their business agreements and KPI's.

Business rule module 54 may create and provide a list of business rules and KPI's to monitor in the performance of a particular contract. In order to monitor the day-to-day performance of the partner relationship, the system architecture may include an Agent process. This Agent may reside within the partner's firewall or within an e-commerce “hub.” It extracts data used to monitors metrics that indicate the health and performance of the partnership. The Agent abstracts the raw data source by way of a collection adapter. The Agent then translates the data and reliably sends it (in a XML stream) to the server.

Agents are built with two layers of abstraction. First is the data collection layer, which is capable of capturing messages in standard (native) formats (e.g., FTP, flat file, MQ Series, XML). It employs adapter architecture so that additional collection adapters can be added at a later stage without the need to rewrite/compile the agent. The second is the data translation layer, which is built upon similar adapter architecture and is a designed to communicate the captured content by mapping from disparate protocols (e.g., EDI, proprietary file, cXML) to a standard XML stream (pXML). This two-part configuration with adapter plug-ins allows for the greatest level of flexibility in data collection and translation.

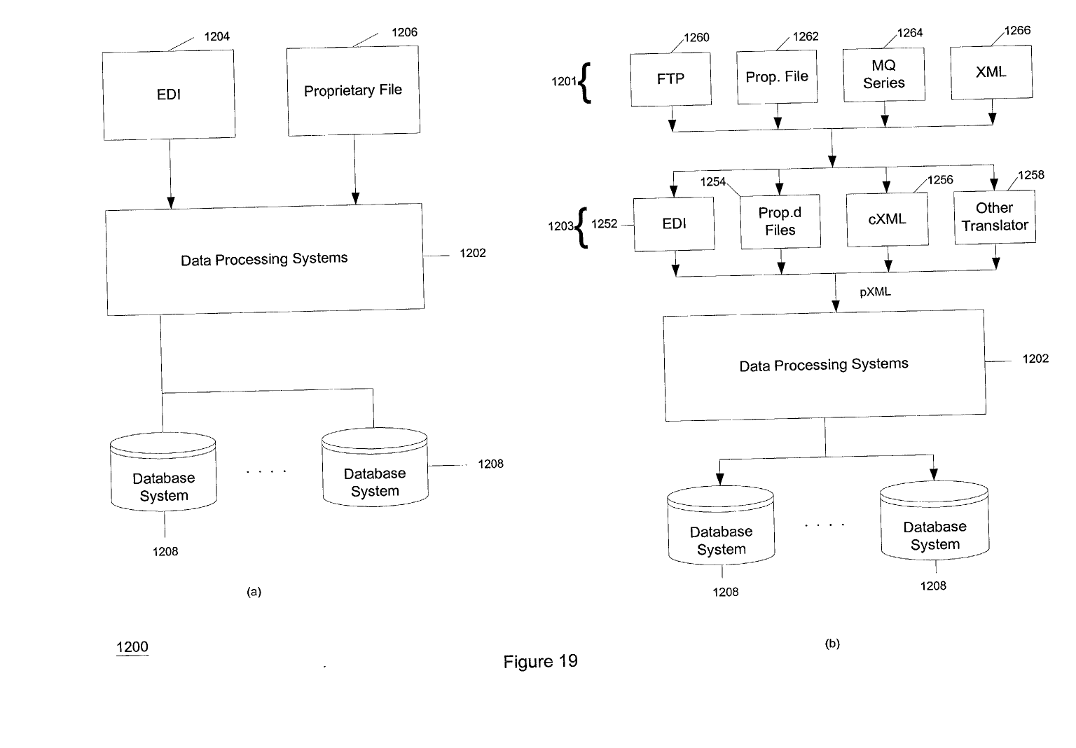

For example, as depicted in FIG. 19(a), one embodiment provides a simple EDI system 1204 or Proprietary file input system 1206 that provides data in those formats to a data processing system 1202 that in turn stores the information in one or more database systems 1208. Dealing with disparate data types can be difficult and while such a system may be used with the present invention, the preferred embodiment, described above, involves two layers of data collection as depicted in FIG. 19(b).

In a first layer, 1201, collectors are provided that enable data to be collected in a variety of formats, including FTP 1260, flat files 1262, MQ Series 1264, and XML collection 1266. Other collectors may also be provided. Once the files are collected through these various systems, the data may then be translated into a standard format such as pXML through one of a plurality of different translators in the translator layer 1203.

Translator layer 1203 may provide EDI translator 1252, Proprietary file format translators 1254, cXML translators 1256, and other translators 1258 as well. The data translated from these formats is then provided to the data processing system 1202 which stores it in pXML format in one or more database systems 1208.

The Input Gateway of the server is responsible for accepting data from agents, parsing it and inserting it into the repository. Subsequent activities within the server are triggered by the arrival of this data or, in some cases, may be triggered by a Timer Service, which is responsible for calling various manager modules and may be set in motion by the arrival of data or a predetermined schedule.

Metrics Manager manages the lifecycle of metrics modules (where each module implements a specific metric/KPI calculation). It coordinates the flow of information to and from metrics modules based upon events that have been registered against objects (partners, locations and items) within the system.

Analytics Manager brings intelligence to the solution. Where Metrics Manager is focused on real-time calculations, Analytics Manager looks forward to predict and recommend courses of action based on pattern recognition technologies and analytical approaches including but not limited to statistical algorithms, complex adaptive systems, and other non-linear analytical techniques.

Event Manager manages the lifecycle of test and event evaluations. Events are tests or compound tests registered against objects within the system with thresholds around which users are to be alerted (warning and critical levels) and notified. If a user is to be notified as a result of event criteria being exceeded, the relevant information is pushed to Notification Manger.

Notification Manager manages construction and delivery of notifications to users. Content and delivery are abstracted for maximum flexibility in communicating relevant information to users in accordance with their preferred delivery terminal device (e.g., e-mail, pager, phone).

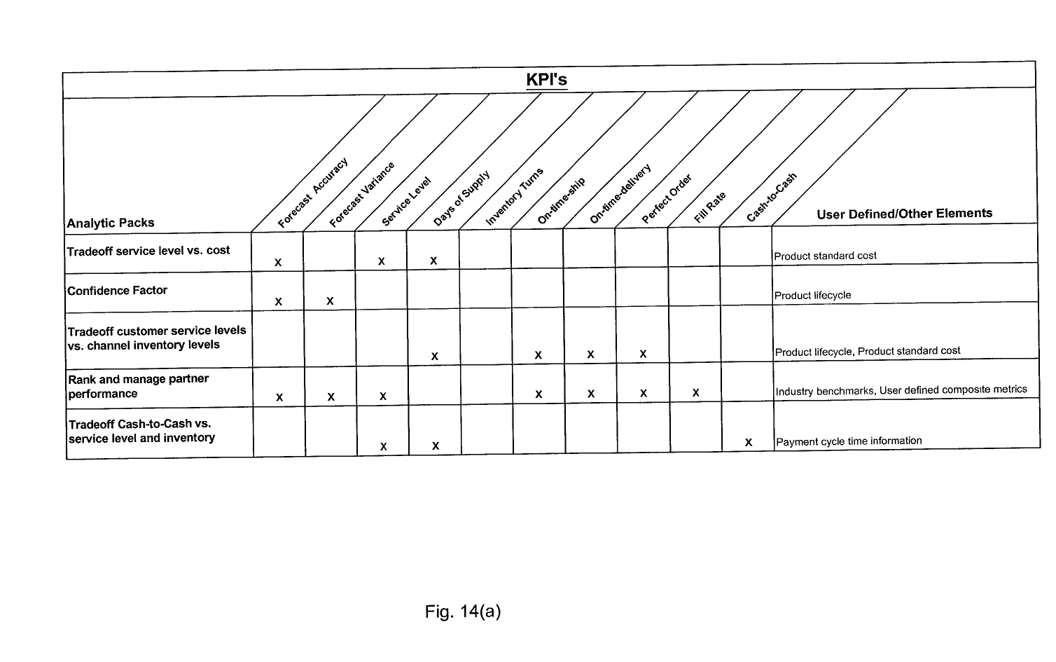

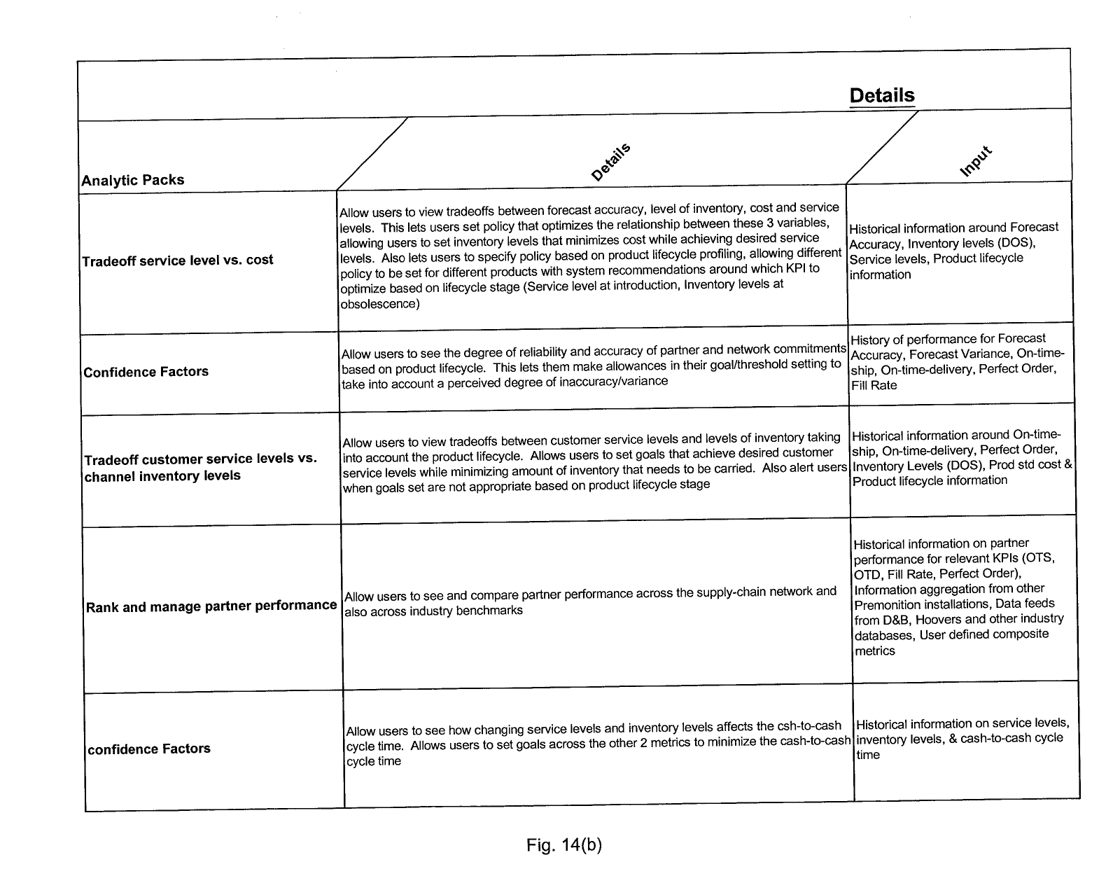

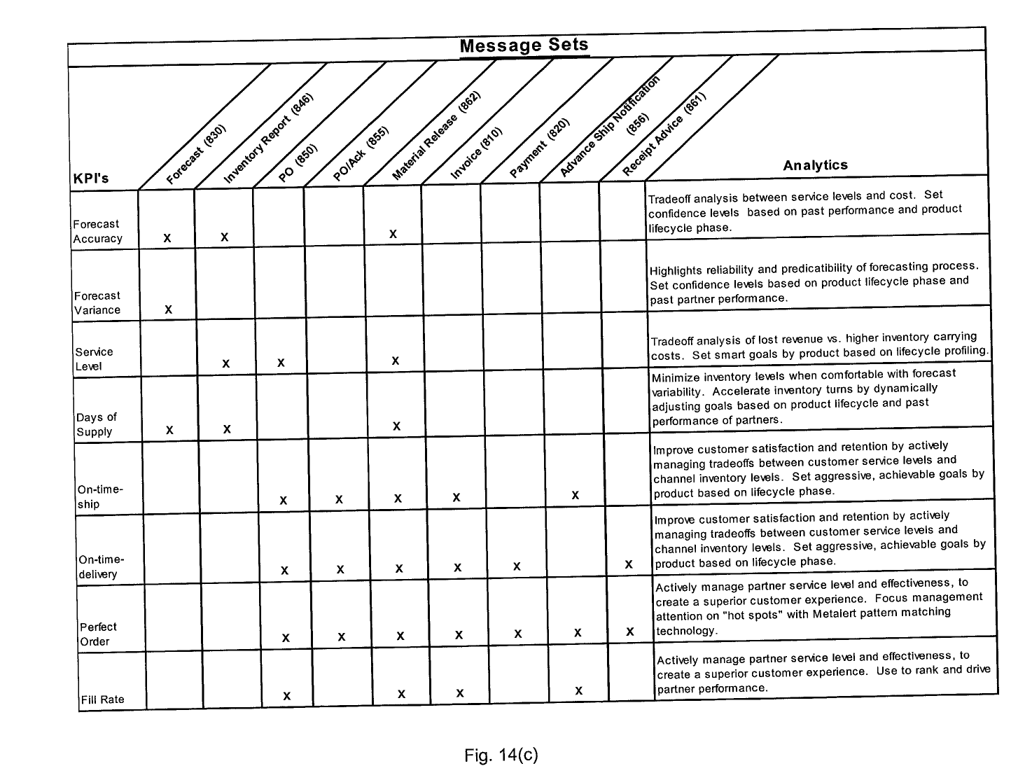

When the Metrics Manager inspects the new data, it may calculate one or more of the following: values for various time windows: forecast error, service level, average consumption, and others. FIGS. 14(a)-(c) provide representative matrices of logical e-commerce message types, KPI's the system derives from them and the analytic functions provided by the system.

In order for the system to know who is responsible for a particular item, it may interrogate the client's ERP system. For this to happen, a read only ERP adapter may be installed at the client site to synchronize master data between the execution system (e.g., Oracle, SAP) and the host system. In this configuration, the user specifies a “part controller ID” and the system filters alerts and reports based on the primary scope of responsibility for the user. For example, if a user is responsible for a specific set of part numbers or a set of commodity types, the system profiles content to reflect these preferences.

Some users (e.g., ones that do not have a direct part controller ID) may wish to use the system and monitor items. If this is the case, the system can allow the administration level users to set up a relationship between the user and one or more part controllers. When this is done, all items that are monitored by the part controllers are visible to the user. The system also enables authorized users to monitor all parts to which they have been granted security access without any special item groupings.

In a preferred embodiment, the user may not have to configure the thresholds that indicate that a problem exists for a particular part. The supply delivery process may be monitored by the system for a predetermined period (i.e., one month), at the end of which the user can take a “baseline” and a deviation of a certain percentage (e.g., 20%) from the baseline causes violations. This may be done with or without the aid of a threshold setting assistant.

The system may periodically (e.g., every month) prompt users with policy setting authorization to confirm an existing threshold setting or adjust to a new setting. This means that the end user does not adjust the thresholds themselves. This may be imposed so that all users are talking about the same alert.

The threshold setting may be calculated using the historical data (the last month) and smoothing the values. If everything stayed the same, the user may only be notified for the exceptional changes.

In an embodiment, the server system defines the SCOR level 1 KPI's/Metrics that can be derived from the message sets the users provide. The solution then determines from this list of metrics those that apply for all parts and those that are typically sensitive to the product life cycle. The system then selects thresholds for these 2 classes of KPI's/Metrics based on industry benchmarks/history for the former (KPI's metrics universally applicable) and based on life cycle trends for like parts/product types for the latter (life cycle dependent KPI's/Metrics). Products may be grouped based on UCC codes and lifecycle stages. The UCC codes are used to group products with similar lifecycles. Lifecycle stages are determined by introduction and obsolescence dates via reading the master data in the ERP system or by pattern matching similar production monitored by the system.

Users are shown these pre-set thresholds in the customize rules section and are allowed to accept/change add to these rules. They are also asked to specify notification lists, mechanisms and escalation paths for when these rules are violated. Over time these rules are changed frequently based on different stages in the product life cycle, and users with policy setting authorization are informed of these changes and asked to accept/modify them. Operational users may be notified of accepted changes. The system tells the user where the problems are—not the user telling the system where to look.

When the user is notified of an issue, they may be asked how relevant the notification was. This feedback is passed into the notification algorithm so that it adapts to how sensitive the user is to the violations over time.

The key to this subsystem is the ability to tune in on the wishes of the user without the user having to spend time configuring the system.

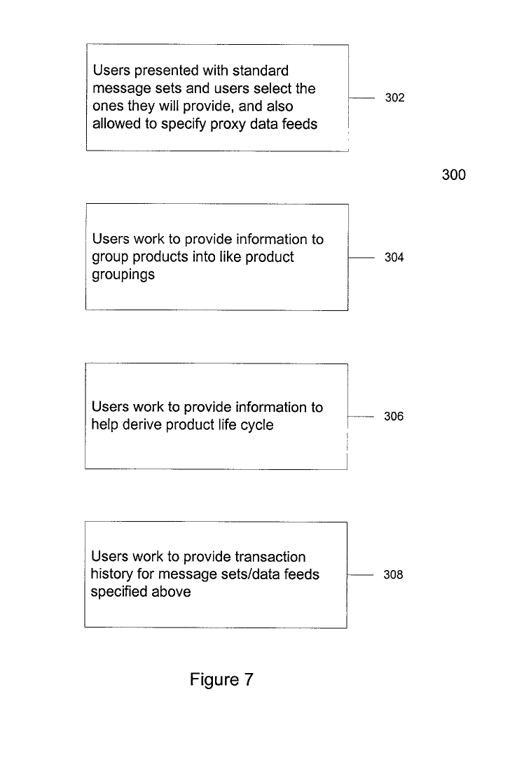

As part of the process of generating preset business rules for a particular partner, a process 300 may be provided that provides information on product life cycle and message transaction history related to that particular partner to go into the preset business rules. FIG. 7 depicts an embodiment of such a process 300. In a first step, 302, users are presented with standard message sets used by the system and users then select the ones that they will provide. They may specify data feeds that will go into the system relating to master data including products, vendors, customers, and employee roles. In step 304, users work to provide information to group products into like product groupings. Next, in step 306, users work to provide information to help derive product life cycle profiles. And then in step 308, users work to provide transaction history for message sets/data feeds specified. The previous transaction histories may be used to recommend relevant KPI's and threshold settings for this particular partner. As part of this module, business rule module 54 may generate one or more of the following outputs.

Input screens may be provided for defining message sets/data feeds to enable a user to provide KPI/Metric calculations. Such screens may also be provided to notify users when products have crossed into a different stage in the product lifecycle with new relevant KPI's and new threshold values and allow users to perform a number of functions. Such additional functions include the ability to: accept changes as is, reject changes and maintain status quo, accept changes but add to the rule (add refers to specifying more/less KPI's/Metrics with different threshold values), and reject changes to define new rule (define refers to specifying different KPI's/Metrics with new threshold values).

Output may also include a list of KPI's /Metrics that can be calculated from message sets/data feeds that users define (List 1), a list of products grouped into like product groupings based on UCC codes (List 2), a list of like products (List 2) grouped by similar lifecycle stages (List 3), segmented list of KPI's/Metrics from above segmented based on KPI's/Metrics that are product life cycle dependent vs. those that are not (List 4), list 3 with all relevant KPI's/Metrics that apply for each product grouping, based on which metrics are relevant at that stage in the product lifecycle (List 5), calculate KPI/Metrics defined above from transaction history of message sets/data feeds by like product groupings, and threshold values for warning and critical level alerts for all KPI's/Metrics in list 5 above.

Business rule module 54 may also provide the following additional features: display screen for users to input message sets/data feeds they can provide to the system, calculate all level 1 SCOR KPI's/Metrics that can be calculated from the specified message sets/data feeds, calculate above KPI's/Metrics from transaction history of message sets/data feeds, segment above KPI's/Metrics into those that are product life cycle dependent vs. those that are not, group products based on UCC codes (to group like parts) and similar product lifecycle stage (derived from introduction and obsolescence dates and UCC codes), derive relevant KPI's/Metrics for product groupings above based on the product lifecycle stage, derive thresholds for all relevant KPI's/Metrics above by product groupings. For product life cycle dependent KPI's/Metrics thresholds based on lifecycle stage, while the remaining based on historical values and industry benchmarks, store all part groupings with relevant KPI's and threshold values for use by other subsystems, monitor product groupings regularly and as they cut across from one lifecycle stage to the next and derive the new relevant KPI's/Metrics that are applicable with the appropriate thresholds, and display screen to users for above product groupings as groupings move from one lifecycle stage to the next, with new relevant KPI's and new threshold values and allow users to: accept changes as is, reject changes and maintain status quo, accept changes but add to the rule (add refers to specifying more/less KPI's/Metrics with different threshold values), and reject changes to define new rule (define refers to specifying different KPI's/Metrics with new threshold values).

Module 54 also provides for customizing of business rules. Some users like to specify some metrics outside the defined KPI list, and need to specify the metric and the message sets/data feeds they provide for calculating these metrics. For all of the calculated metrics, users may set alert thresholds at both the operational and management level. The user may specify to whom these alerts should be delivered (notification list), and the communication vehicle (messaging protocol) and escalation path (if defined) to be used.

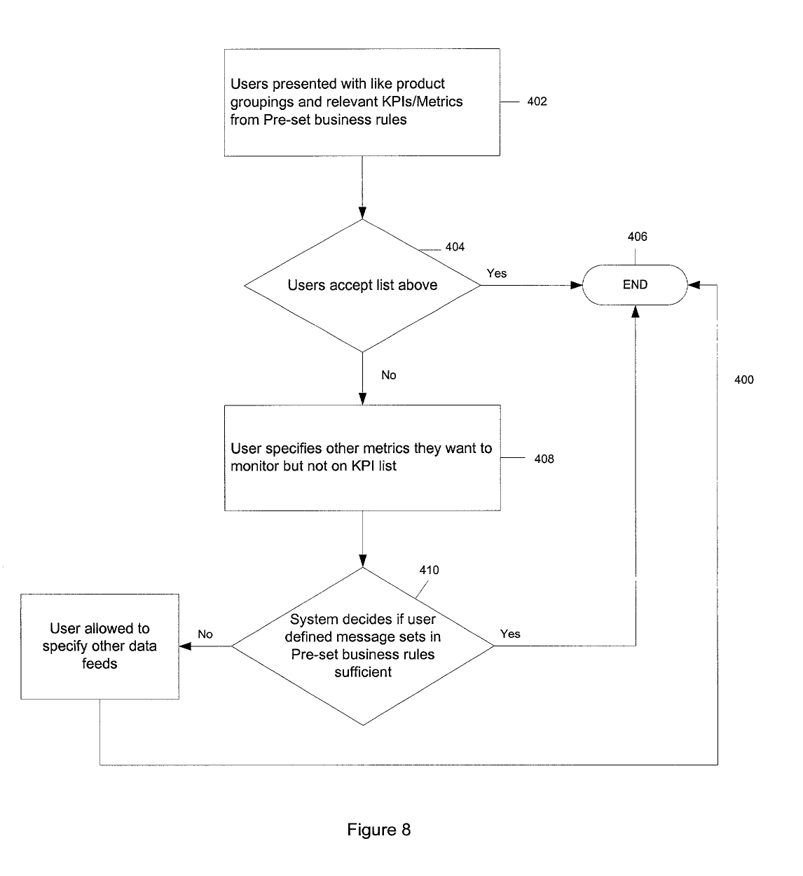

As described above, a process may also be provided to enable a user to customize the preset business rules in a process 400. FIG. 8 depicts one embodiment of the process 400 for customizing the business rules for a particular user. First, in the step 402, users are presented with like product groupings and relevant KPI's/metrics from the preset business rules. Next, in step 404, the users may either accept the list above and if so, the process terminates in step 406, or if not, then in step 408, the user specifies other metrics that they want to monitor but are not on the current key performance indicator list. In step 410, the system determines if the user defined message sets in the preset business rules are sufficient. If they are not, the user is allowed to specify a data feed that will provide the information necessary to be monitored and then the process terminates in step 406.

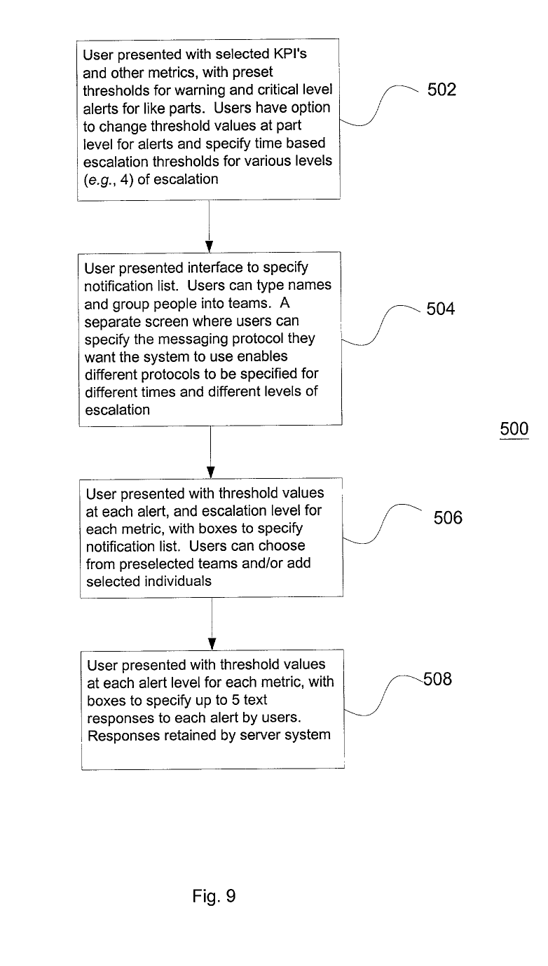

The system may also provide users with the ability to set operational alert thresholds, notification lists, and to specify escalation paths and operational response definitions for each alert. This may be provided in a process 500 as for example depicted in FIG. 9. In process 500, in a first step 502, the user is presented with selected KPI's and other metrics, as well as preset thresholds for warning and critical level alerts for like parts. Users then have the option to change threshold values at the part level for alerts and to specify time based escalation thresholds for various levels of escalation. The levels of escalation may be four, for example. Next, in step 502, the user is presented with an interface to specify a notification list. Users can type names and group people into teams as well. A separate screen where users can specify the messaging protocol they want the system to use enables different protocols to be specified for different times and different levels of escalation. Next, in step 506, the user is presented with threshold values at each alert and escalation level for each metric with boxes to specify notification lists for each of the different levels and escalation levels. Users then can choose from pre-selected teams and/or add selected individuals. Next, in step 508, the user is presented with threshold values at each alert level for each metric with boxes to specify up to five text responses to each alert by user. The responses are then stored on the server system for future reference.

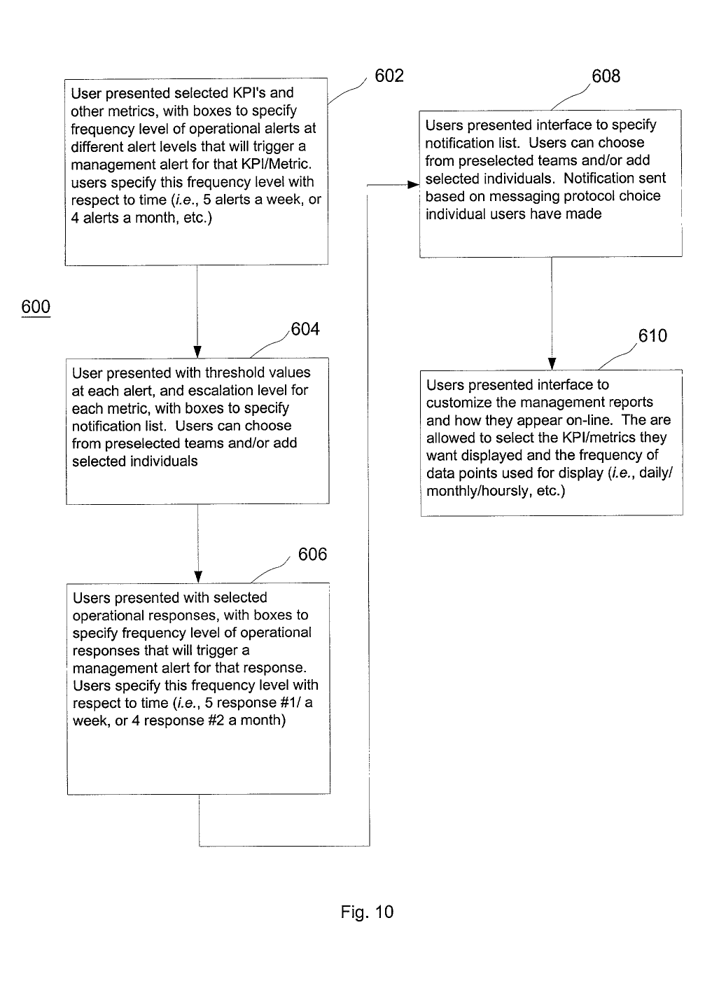

Different levels of thresholds may also be preferably set for the management level as opposed to the operational level as specified in FIG. 9. These alerts about alerts are called Metalerts. They are different from commercially available compound KPI's in that Metalerts are triggered based upon frequency and/or severity of alerts triggered by individual and/or combined KPI performance issues and/or operational alerts and/or responses to those operational alerts. This ability to highlight structural “hot spots” for management teams in networked supply chains is another key advantage of the system of the present invention. For example, a process 600 may be provided as, for example, depicted in FIG. 10 for setting management level alerts. In a first step 602, users are presented with selected KPI's and other metrics with the ability to specify the frequency level of operational alerts at different alert levels that will trigger a management alert for that particular key performance indicator or metric. For example, users may specify the frequency level with respect to time, i.e., five alerts a week, or four alerts a month, for example. Next, in step 604, users are presented with an interface to specify the notification list. The initiator of an alert is assumed to be the “owner” and generally are the “first line” of notification. Alert owners may assign resolution responsibility to other authorized users, but one and only one user has resolution responsibility for an alert at any one time.

Users can choose from pre-selected teams and/or add selected individuals. As part of this process, the notification sent may be based on messaging protocols made by individual users. Next, in step 606, users are presented with selected operational responses to specify the frequency level of operational responses that trigger a management alert for that response. Users specify this frequency with respect to time as well in one embodiment. Next, in step 608, users are presented with an interface to specify the notification list. Users can choose from pre-selected teams and/or add selected individuals. Again, here the notification may be sent based on messaging protocols specified by the individual users. Next, in step 610, users are presented an interface to customize the management reports and how they appear on line. Users are allowed to select the key performance indicator/metrics they want displayed and their frequency of data points used for display, i.e., daily, monthly, hourly, etc.

Performance monitoring module 56 may be provided to monitor based on the business rules and other criteria the performance of a particular contract.

The system provides alert severity functionality. A deviation from the baseline can generate a “Warning” severity alert and further (larger) deviations can escalate the severity to “Error.” As many levels of severity as desired may be provided depending on the granularity desired. For example, by analogy, alerts may be green light, yellow light and red light conditions depending on severity. Regardless of the names associated with the alert, the system sets a hierarchical set of alerts, conditions for each, and a response for each. For example, the current moving average may be compared against the baseline and if the average is outside the buffer an alert is generated.

Only one alert may be allowed per item/location/alert type (this may be true for system-wide alerts, but individual users may specify individual alert thresholds with team notification lists, and so the possibility for multiple alerts (one system-wide and multiple individuals) alerts exists at an item/location/alert type combination).

It should be appreciated that the system may send a single alert for a condition that triggered the alert. Then, the system does not re-send the same alert unless there has been an important time-based or severity-based change in status (as previously defined by the user).

Further, authorized users can create their own alert and indicate other people to notify given certain criteria, so a single person may get multiple alerts about the same thing until they correct their personal notification preferences.

If the severity of the alert escalates, then a change is indicated in both the notification and the system's main server system to monitor for business rules. If any business rules are violated or other conditions under the alerts are met, then in step 114 notifications may be issued to order more partners. Each user has the option to have alerts delivered to their e-mail account or via other notification mechanisms. The notification contains information about the outstanding issues and which items they affects. Within the e-mail there is a URL that directs the user to the server. When the user connects to the server, they are presented with a list of the outstanding issues. The list is a subset of the total outstanding issues (filtered by a list of users associated with a particular item for which an alert was indicated). The issue stays on the outstanding list until the user closes the alert or until the server has received relevant new messages. For example, the arrival of an advanced shipment notification may close an open on time ship alert. Resolving the issue within the resolution subsystem or just removing the issue from the list can accomplish the closure. The frequency of the notification may be adjusted on a per user basis. Also, an option to be paged for stock-out situations is provided.

Resolution/collaboration module 58 may provide the functionality to help resolve issues which arise due to violations of agreements or other such events captured in the course of operations.

The system allows the user to invite parties to collaborate on the resolution of an issue. The resolution environment is an “always open” secure electronic meeting room. It allows the parties to exchange ideas/documents and provides a mechanism to closeout the issue when an acceptable resolution is achieved. When a user wishes to resolve an issue, they can initiate a resolution session. The system allows them to “invite” other parties to collaborate of the resolution of this issue. The user invites other parties by supplying their e-mail address and some text message. The server system sends an e-mail message to the parties giving instruction on how to join the team. If the invited party is not an existing user, the user is asked to register before entering the system.

Service catalog module 60 may be provided to enable the input of new partners, new data, new products, new templates and other information into the database storage system used as part of the supply chain management.

When a user wishes to find a new partner, they first need to locate the partner. This step involves filtering the potential list of partners using a number of attributes, some may be industry focus, geographic location, size of company etc.

Once the user has a short list of partners, they now perform a more in-depth investigation of the company. This may involve obtaining a third-party vendor request (e.g., a Dun & Bradstreet Supplier Evaluation Report) or other financial documents, for example. Once the user has selected one or more potential partners they move into the RFP/RFQ process (Partner Selection). The partner directory performs a number of functions, including: partner data collection, partner data storage, and partner data maintenance. The directory contains basic profile information about a partner as well as links to more advanced information.

A partner entry in the directory may be created as a seed entry. This is an entry that is not yet complete, but has enough information for the system to populate the rest of the basic partner information using its own resources.

The seed entry contains the mandatory fields without which the system or human researchers could not uniquely identify the partner. These fields include: partner name, partner address, and partner telephone number.

When a new seed entry is entered into the system, a process is scheduled to research the partner. This research process takes the seed entry and queries profile data feeds. If a match cannot be found, human research may be performed and input to the system. The researcher investigates the partner and either rejects the partner entry or inputs the background information via the researcher web front-end. Researchers may be users, certified third parties, automatic agents, or employees operating at the host server system site. If the researcher finds a new electronic source for the profile information, the data source can be added to the list of profile data feeds.

The profile data feed is taken from multiple web sites and/or other sources. The system has a concept of an “electronic researcher” called the collector. This is a process that hunts for information about a partner. The collector loads a list of collector modules called extractors and instructs each one in turn to return the profile information about the partner. If the first extractor does not return the information, the next extractor is tried. The extractor encapsulates the knowledge about a particular data source and provides a standard interface to the collector.

The directory may store its information in a RDBMS. A partner table contains the basic information the partner and a links table provides the bridge between the partner and the specific URLs needed to access the advanced information.

Over time the directory may become out of date without regular data maintenance. The directory contains a housekeeping task that cycles through the partner entries and reloads the profile information with more recent copies. Similar housecleaning functions may be executed to remove obsolete master data (e.g., partner, location, item) when read only master data adapters are not in place between user execution systems (e.g., Oracle, SAP, i2) and the system. For example, a periodic utility may be run to identify all objects known to the system, which have not been referenced over a user-configurable timeframe. These objects may be automatically deleted or brought to the attention of appropriate users for disposition.

The housekeeper updates the partner entries (e.g., oldest first) using a slow background pull. As each entry is updated, its timestamp is incremented and therefore is not a candidate for the next update cycle. The housekeeper is multithreaded, but limits the number of active collectors.

Decision support module 62 may be provided to track and maintain a database of prior decisions as to resolution of an issue to analyze trends between parties and the like.

In one embodiment, making use of the text retrieval capabilities of Oracle's database a fully searchable resolution database may be produced. The system searches previous resolutions and provides the user with a mechanism to perform ad-hoc queries against previous resolutions.

The resolution data is accessed in two ways. The first is for ad-hoc investigation (like a bug database) and the second is by the resolution system to generate a summarized list of associated resolutions. In order to generate the “associated” list, the resolution system generates queries against the test type, item and location.

Transaction linking module 64 may be provided to link partners to other outside transaction systems. Service catalog update module 66 may be provided to update the service catalog based on learned performance criteria from other systems in this environment. Business rule adaptation module 68 may be provided to update business rules based on other criteria selected through the process. Business rule approval module 70 may be provided to enable a system user or other individual or individuals to approve new business rules prior to their implementation of a system. Business document monitor module 72 may be provided to monitor the flow of business documents between partners and the process including orders, change for change of orders, invoices, payment histories, etc to be able to evaluate the actual performance between these two partners in this business arrangement. Event monitoring engine 74 may be responsible for monitoring events that transpire between partners in initiating some action to track and evaluate that particular event's impact on performance between the parties. These events may be, for example, the conditions specified in FIG. 14, for example, as the conditions that trigger an alert. Alert module 76 may be provided to initiate alerts based on violations detected by performance monitor module 56.

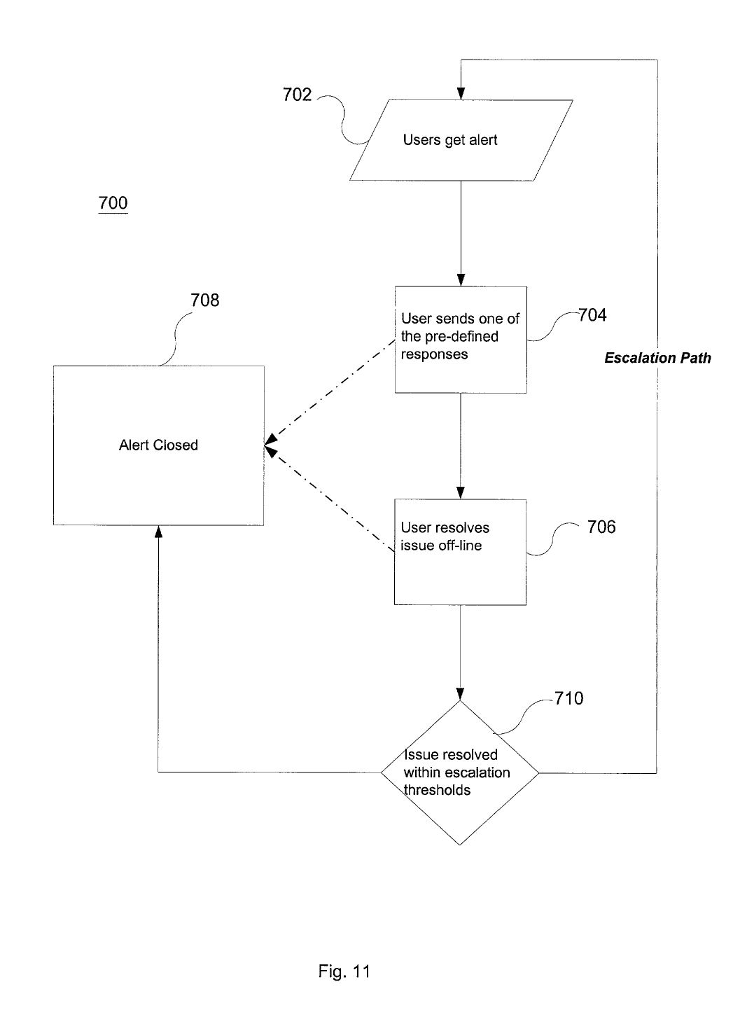

Alert module 76 is responsible for generating alerts and may also be responsible for sending escalating alert messages. For example, if a first person who receives an alert does not take an action, then a higher level alert may be triggered that causes a second level or higher level distribution list to be notified. Escalation threshold may be time, or a specific response as well. For example, FIG. 11 depicts one embodiment of a process 700 whereby escalating alerts are sent according to an embodiment of the present invention. In this embodiment, in step 702, the first alert is sent to a number of users. Next, in step 704, the user may send one of predefined responses to a particular alert to resolve that alert issue. If so, then in step 708, the alert may be closed. If one of the predefined responses is not received, the user may also in a preferred embodiment be able to resolve the issue off line in step 706 and subsequently close the alert in step 708. Alternatively, if neither of these conditions are met, then step 710 monitors to determine whether the issue has been resolved within escalation thresholds and if so closes the alert. If not, then in step 710, an escalated threshold is exceeded and step 702 continues with a higher level of alert being initiated by the process.

The alert module 76 also provides one or more of the following functions: customized business rules for non-arrival and early or late arrivals, and for defined metric values, sending alerts and escalations based on alert thresholds, notification lists, escalation path, and user preferences around messaging protocols for both operational and management level alerts, allowing outputs to e-mail, fax, pager (2-way), and WAPI device, support following messaging protocols: E-mail, Fax, 2-way pager, WAPI device, maintaining notification log including details of notifications (who it was sent to and when) and details (how many, when) of pre-defined responses, and summarizing and display the following on-line reports, alert summary by alert level by Product/Vendor/Location, and operational alert response summary by response type by Product/Vendor/Location.

Decision request system 78 may be provided to solicit decisions from business partners concerning issues, opportunities, KPI thresholds, and alerts.

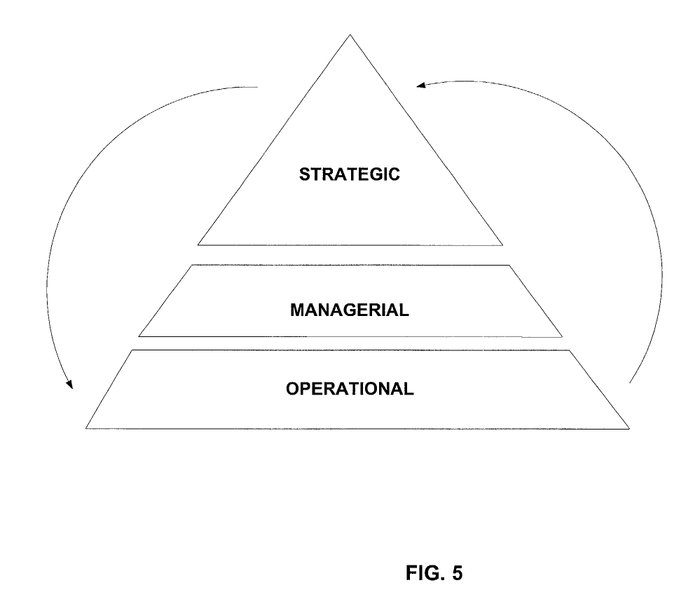

As discussed above, these modules may be provided on a single server system or may be disbursed across many different server systems to provide the functionality to execute the process described herein. Additionally, the server systems may rely on data that is stored in a database system 28. It should be appreciated that, although one database is shown, that the data depicted may be distributed among a variety of different databases that may either be connected, networked, or any other arrangement of data that is accessible by the modules in some of the data stored in a database. This data stored may comprise partner data, agreement templates, message adapter details, RFP/RFQ templates, terms and conditions, violations, trends, resolution, KPI's, business rules, communications-extracted data, and thresholds. As a result of this system, details of operational performance automatically inform strategic sourcing decisions by virtue of the composite ranking of partners based on overall performance. Conversely, strategic decisions (e.g., changes to partner agreements) are rapidly and consistently disseminated through a process of linking agreements to KPI's, alerts, and thresholds. The effect of this closed loop process is continual, informed adjustments of both strategies and tactics. Ultimately, this produces greater supply chain flexibility and adaptability. Such is depicted in FIG. 5.

As described above, one of the benefits of the system is to provide templates to enable partners to establish an agreement. Also, according to one embodiment of the present invention, pattern matching, statistical, and complex adaptive system technology may be employed as part of the monitoring process to determine violations, trends, correlation, and severity.

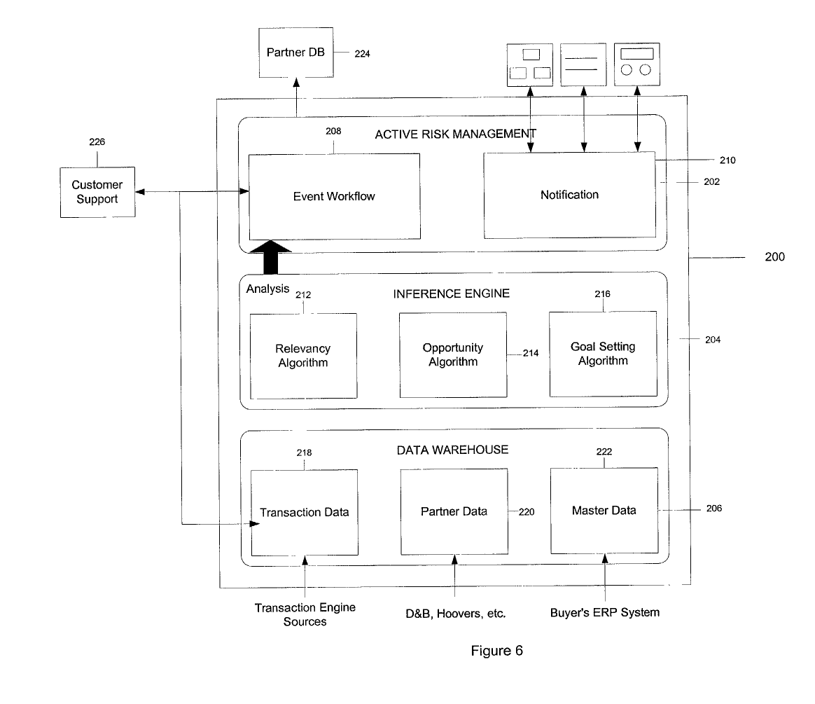

FIG. 6 depicts another embodiment of the present invention in which the flow of data through the system is depicted in diagram 200. Specifically, there are three major components in this diagram, the operational risk management component 202, the inference engine 204, and the data warehouse 206. Data warehouse 206 is supplied with different types of data including transaction data 218. Such as from transactional engine sources such as trading hubs, VAN's, and e-Markets. Partner data may be supplied by the partners themselves or may be automatically downloaded from partner resources such and Dunn and Brad Street, Hoovers another company an enterprise data sources. Additionally, master data 222 may be supplied such as from the buyers ERP systems. The data warehouse is then supplied to an inference engine 204 for analysis. The inference engine may use a relevancy algorithm 212, opportunity algorithm 214, and a goal setting algorithm 216. The inference engine then passes analysis up to the active risk management portion 202 which provides notification to various output devices and as well as managing event workflow. Event workflow is then output to partner databases 224 and the customer support system 226 which then provides input right back into the data warehouse.

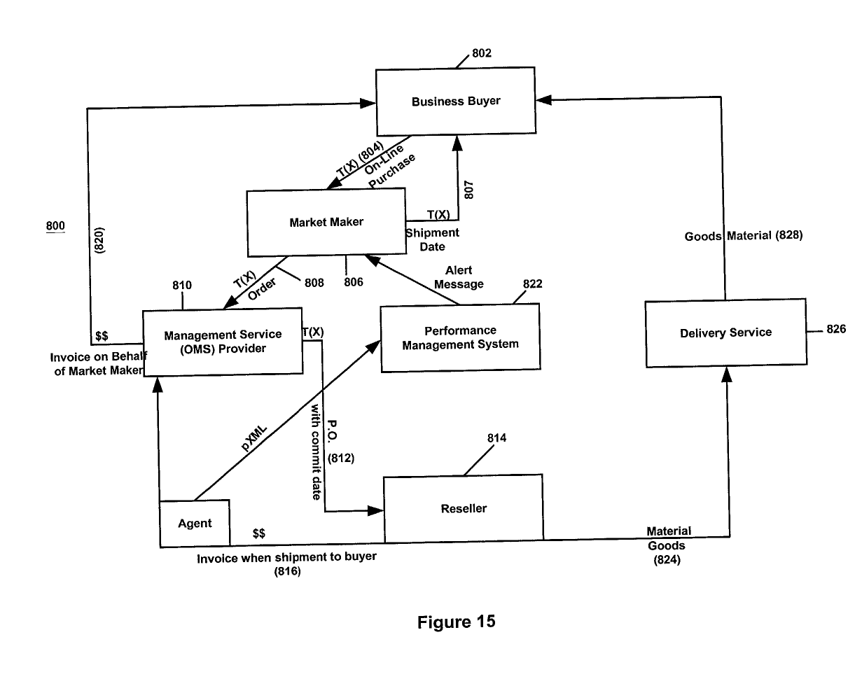

FIG. 15 depicts an example of a flow of information and material in a system of the present invention. In particular, a flow 800 is provided in which a business buyer 802 makes an on-line purchase with a market maker 806. The purchase information 804 is provided in T(x) format. The market maker 806 then provides a shipment date message 807 to the business buyer 802 via T(x) as well. The market maker 806 then provides the order 808 in T(x) format to a management service (OMS) provider 810. The management service provider 810 then provides a purchase order with a commit date in a message 812 to a reseller 814 in T(x) format as well.

When the reseller 814 ships the materials purchased (824) either directly or through a delivery service 826 providing the materials (828), the reseller 814 generates an invoice 816 that is passed through an agent 818 to the management service provider 810. If the agent 818 detects that the shipment exceeded the commit date specified, then a pXML message is sent to the performance management system 822 of the present invention. The performance management system 822 may then generate an alert message to the market maker to alert the market maker that the reseller had not fulfilled the order according the commit date. Additionally, the management service provider 810 may invoice 820 the business buyer for the purchase of the material. This flow is one example of how the performance based supply chain management system of the present invention operates.

As a result of the use of the present invention, buyers and sellers are connected to the right partners in real time, or are automatically able to identify the most profitable partnership opportunity based on real performance information about those potential partners, can identify unproductive or inefficient partnerships and take action to correct or replace them, and dynamically respond to changing market conditions. Additionally, the present invention maximizes the value of every supply chain relationship by substantially reducing the time and cost of ensuring quality of service, connecting operational decisions to strategic decisions, in quantifying critical tradeoffs among related performance measures. As a result, partners in the system can focus on customers, products, and partners that need it most. The present invention transcends existing application-to-application communication technologies by enabling true business community integration. This integration is provided with automatic update of partner profiles, suggestions for alternatives when appropriate, proactive notification of issues (with relevant content in context, and tools for secure, collaborative resolution), archiving functionality for institutional knowledge retention, and continuously updated, predictive analytics that recommend what to watch and what performance thresholds appear to be reasonable.

The more the system is used, the more useful it becomes because of the unique content and context retained in the system. Private trading networks will develop both broad based context around partner relationships and detailed procedural content that represents the tacit, distributed know how required for operational excellence.

For example, data sets increase with the addition of new customers therefore there is more data to draw from. The analytics increase in accuracy over time, the alerts are refined, users realize increased cost savings, savings thus tallied become inherent in the product, sales cycles thus compresses, and so forth. Users then benefit where more entities are participating because the data set includes anonymous, aggregated performance benchmarks for partners, commodities, and regions. This content is used by the system to refine analytics and predictive recommendations, develop comparative performance profiles, and compare specific product performance profiles against industry benchmarks.

Other embodiments and uses of the invention will be apparent to those skilled in the art from consideration of the specification and practice of the invention disclosed herein. The specification and examples should be considered exemplary only. The scope of the invention is only limited by the claims appended hereto.

What is claimed is:

1. A stateless, event-monitoring computer system for use in monitoring events based on data and user interfacing, the computer system comprising:
a user interface web cluster comprising redundant web servers for bi-directional communications with users regarding events to be monitored between the users;
a data gateway web cluster comprising redundant web servers that provides a one-way data collection module for data;
at least one database cluster connected to the user interface web cluster and the data gateway cluster to access and store data to a database system; and
at least one application processing cluster connected to the database cluster to provide an application related to the events being monitored for the users.

2. The system of claim 1 wherein the at least one database cluster comprises a load-balanced system with redundant web servers.

3. The system of claim 1 wherein the at least one application cluster comprises a load-balanced system with redundant web servers.

4. The system of claim 1 wherein event being monitored is performance in a supply chain by buyers and suppliers participating in an on-line performance based supply chain management system.

5. The system of claim 4 wherein the data gateway cluster collects data related to products being supplied and participants of the system for use in enabling participants to engage other participants in a contractual relationship for supply of one or more of the products.

6. The system of claim 4 wherein the user interface cluster enables buyers and suppliers of the supply chain management system to interact relating to various aspects of a supply chain management process.

7. The system of claim 6 wherein the aspect comprises setting up an environment in which buyers and suppliers interact.

8. The system of claim 6 wherein the aspect comprises assisting buyers and suppliers to engage in contractual relationships for the supply of goods or services.

9. The system of claim 6 wherein the aspect comprises assisting monitoring performance of contractual relationships between buyers and suppliers based on a key performance indicators selected by the buyer and supplier for a particular contractual relationship.

10. The system of claim 6 wherein the aspect comprises enabling buyers and suppliers to collaborate to resolve issues relating to the contractual relationship.

11. A stateless, event-monitoring server system for use in monitoring performance between buyers and suppliers participating in a performance-based, supply chain management system, the server system comprising:
a user interface web cluster comprising redundant web servers for bi-directional communications with users regarding events to be monitored between the buyers and suppliers;
a data gateway web cluster comprising redundant web servers that provides a one-way data collection module for data related to products being supplied, buyers, and suppliers;
at least one database cluster connected to the user interface web cluster and the data gateway cluster to access and store data to a database system; and
at least one application processing cluster connected to the database cluster to provide an application related to the events being monitored related to a buyer-supplier engagement.

12. The system of claim 11 wherein the at least one database cluster comprises a load-balanced system with redundant web servers.

13. The system of claim 11 wherein the at least one application cluster comprises a load-balanced system with redundant web servers.

14. The system of claim 11 wherein the user interface cluster enables buyers and suppliers of the supply chain management system to interact relating to various aspects of a supply chain management process.

15. The system of claim 11 wherein the aspect comprises setting up an environment in which buyers and suppliers interact.

16. The system of claim 11 wherein the aspect comprises assisting buyers and suppliers to engage in contractual relationships for the supply of goods or services.

17. The system of claim 11 wherein the aspect comprises assisting monitoring performance of contractual relationships between buyers and suppliers based on a key performance indicators selected by the buyer and supplier for a particular contractual relationship.

18. The system of claim 11 wherein the aspect comprises enabling buyers and suppliers to collaborate to resolve issues relating to the contractual relationship.
